(19) United States
(12) Patent Application Publication
(10) Pub. No.: US 2015/0049130 A1
(43) Pub. Date: Feb. 19, 2015

(54) OPTOELECTRONIC DEVICE AND METHOD FOR DRIVING SAME

(71) Applicant: SAMSUNG DISPLAY CO., LTD., Yongin-City (KR)

(72) Inventors: Eiji KANDA, Yokohama (JP); Takeshi OKUNO, Yokohama (JP); Naoaki KOMIYA, Yokohama (JP)

(21) Appl. No.: 14/524,383

(22) Filed: Oct. 27, 2014

Related U.S. Application Data
(63) Continuation of application No. PCT/JP2013/061954, filed on Apr. 23, 2013.

(30) Foreign Application Priority Data
May 1, 2012 (JP) 2012-104982

(51) Int. Cl. G09G 3/32

(52) U.S. Cl. CPC G09G 3/3225
USPC 345/690; 345/77

(57) ABSTRACT

An optoelectronic device includes a first power supply line and a second power supply line extending between two adjacent columns of pixel circuits. A first voltage and a second voltage are alternately applied to each of the first and second power supply lines. The first voltage may be a power voltage, and the second voltage may be an initialization voltage. The first and second power supply lines extend in a direction parallel to data lines and are perpendicular to gate lines connected to the pixel circuits. The first power supply line is connected to even-numbered rows of the pixel circuits, and the second power supply line is connected to odd-numbered rows of the pixel circuits. Each of the pixel circuits includes a capacitive circuit connected between one of the gate lines and a driving transistor. The capacitive circuit stores a voltage to boost a gate voltage of the driving transistor.

### CROSS-REFERENCE TO RELATED APPLICATIONS

This application is a continuation of pending International Application No. PCT/JP2013/061954, filed on Apr. 23, 2013, and entitled “Electro-Optical Device and Method for Driving Same,” the entire contents of which are hereby incorporated by reference. Japanese Application No. 2012-104982, filed on May 1, 2012, and entitled: “Electro-Optical Device and Method for Driving Same,” is incorporated by reference herein in its entirety.

### BACKGROUND

1. Field

One or more embodiments described herein relate to an optoelectronic device and a method for driving the same.

2. Description of the Related Art

A display has been developed that generates images from pixels that use organic electroluminescence (EL) light-emitting devices. In each pixel, the grayscale value of light is controlled by adjusting an amount of current supplied to the EL device. If a characteristic (e.g., threshold voltage or electron mobility) varies, image quality may be adversely affected. Also, in these displays, it is difficult to achieve a sufficient light-emitting duty ratio based on a ratio of the number of pixels turned on to the number of pixels turned off per frame. This difficulty may also reduce display quality.

### SUMMARY

In accordance with one embodiment, an optoelectronic device includes a plurality of pixel circuits arranged in a matrix; a set of power supply lines extending in a first direction, the set of power supply lines including a first power supply line and a second power supply line between two adjacent columns of pixel circuits, a first voltage and a second voltage to be alternately applied to each of the first and second power supply lines; a plurality of data lines, extending in the first direction, to transfer data voltages; and a plurality of gate lines, extending a second direction intersecting the first direction, to transfer control signals.

Each of the plurality of pixel circuits includes a light-emitter to emit light with a luminance based on an amount of applied current, a write control transistor connected to a corresponding one of the plurality of data lines, the write control transistor to control writing of a data voltage, a driving transistor to control the amount of current applied to the light-emitter, a power supply control transistor connected to one of the first power supply line and the second power supply line, the power supply control transistor to control supply of the first voltage or the second voltage; a switching transistor connected between a gate of the driving transistor and a source or drain of the power supply control transistor, the switching transistor to control a gate voltage of the driving transistor; and a capacitive circuit having one terminal connected to the gate of the driving transistor and another terminal connected to one of the plurality of gate lines. The capacitive circuit holds a voltage corresponding to a gray scale value. The first power supply line and the second power supply line are respectively connected to even-numbered rows and odd-numbered rows of pixel circuits in the two adjacent columns.

The capacitive circuit may be connected to a first gate line to receive one of third or fourth voltages, the fourth voltage higher than the third voltage. The device may include a power supply line control circuit to control driving of the set of power supply lines, wherein the power supply line control circuit is disposed along the first direction.

The write control transistor, the driving transistor, the power supply control transistor, and the switching transistor may have a first conductivity type. The first conductivity type may be p-type. One of the data voltages may be lower than a light-emitting threshold voltage of the light-emitter.

The power supply lines, to which the first voltage is supplied during a first period, may be connected to a first line extending the second direction, and the power supply lines, to which the second voltage is supplied during the first period, may be connected to a second line extending the second direction.

In accordance with another embodiment, a method for driving an optoelectronic device includes alternately supplying a first voltage and a second voltage to each of a first power supply line and a second power supply line connected to pixel circuits in adjacent columns, the second voltage different from the first voltage; supplying current to a light-emitter through a driving transistor in at least one pixel circuit supplied with the first voltage; and supplying the second voltage to a capacitive circuit through a switching transistor in the at least one pixel circuit supplied with the second voltage.

The method may include writing a data voltage through a write control transistor in the at least one pixel circuit supplied with the first voltage. The method may include supplying one of a third voltage or a fourth voltage to a gate line connected to the capacitive circuit, the fourth voltage greater than the third voltage. The method may include supplying a data voltage to the at least one pixel circuit, the data voltage less than a threshold voltage of the light emitter. A control signal for controlling gate voltages of switching transistors of pixel circuits in a 2N-th row of pixel circuits and a control signal for controlling gate voltages of write control transistors of pixel circuits in a 2N−1st row may be shared.

In accordance with another embodiment, a method for controlling a driving circuit of a plurality of pixel circuits includes initializing a potential held by a capacitive circuit of a pixel circuit, the initializing including turning off a write control transistor of the pixel circuit in a 2N-throw during a first period, the pixel circuit to receive a first voltage is supplied to the power supply line; supplying a predetermined data voltage to a data line by turning off a write control transistor of the pixel circuit in the 2N-th row during a second period, where a second voltage is supplied to the power supply line after the first period; writing the predetermined data voltage at the pixel circuit at the 2N-th row through the write control transistor and boosting the written voltage during a third period, where the first voltage is supplied to the power supply line after the second period; and supplying current to a light emitter of the pixel circuit at the 2N-th row through the driving transistor after the third period.

In accordance with another embodiment, a method for controlling a driving circuit of rows of pixel circuits includes programming a data line connected to pixel circuits with a data voltage that corresponds to a gray scale value, the programming including turning off write control transistors of the pixel circuits in all rows, so that a data voltage corresponding to the gray scale value is supplied to the data line, and initializing a potential held by a capacitive circuit in a pixel circuit at a 2N-th row, the initializing including turning on a power supply control transistor and a switching transistor of the pixel circuit at the 2N-th row, wherein the programming and the initializing are performed in a first period in which a first voltage is supplied to a power supply line connected to the pixel circuit at the 2N-th row.

In accordance with another embodiment, an optoelectronic device includes a first column of pixel circuits; a second column of pixel circuits; first and second power supply lines extending between the pixel circuits in the first and second columns, each of the first and second power supply lines to alternatively carry first and second voltages to the pixel circuits, wherein the first power supply line is connected to even-numbered rows of the pixel circuits and the second power supply line is connected to odd-numbered rows of the pixel circuits.

The first and second power supply lines may be parallel to data lines connected to the pixel circuits in the first and second columns. The first and second power supply lines may extend in a direction which crosses a direction in which gates lines connected to the pixel circuits extend.

Each of the pixel circuits may include a capacitive circuit connected between one of the gate lines and a driving transistor, the capacitive circuit to store a voltage to boost a gate voltage of the driving transistor. Each of the first and second power supply lines may be connected to a pixel circuit in the first column and a pixel circuit in the second column. The first voltage may be a power voltage, and the second voltage may be an initialization voltage.

### BRIEF DESCRIPTION OF THE FIGURES

Features will become apparent to those of ordinary skill in the art by describing in detail exemplary embodiments with reference to the attached drawings in which:

FIG. 1 illustrates an embodiment of an electronic device;

FIG. 2 illustrates an embodiment of a de-multiplexor;

FIG. 3 illustrates an embodiment of a pixel circuit;

FIG. 4 illustrates examples of power supply lines between columns of pixels;

FIG. 5 illustrates an example of a relationship between potentials of voltages;

FIGS. 6 and 7 illustrate an embodiment for correcting variation in a threshold voltage of a driving transistor;

FIG. 8 illustrates an example of signals for pixel circuits;

FIGS. 9A-9F illustrate states of pixel circuits according to one embodiment;

FIG. 10 illustrates a timing diagram for pixel circuits for another embodiment;

FIG. 11 illustrates another embodiment of an optoelectronic device;

FIGS. 12A and 12B illustrate images displayed on a gray background according various embodiments;

FIG. 13 illustrates another embodiment of an electronic device;

FIG. 14 illustrates another embodiment of a de-multiplexor;

FIG. 15 illustrates another embodiment of a pixel circuit;

FIG. 16 illustrates another embodiment of timing of signals for pixel circuits;

FIG. 17A-17E illustrate states of pixel circuits for another embodiment;

FIG. 18 illustrates another embodiment of timing of signals for pixel circuits;

FIG. 19A-19E illustrate states of pixel circuits for another embodiment;

FIG. 20 illustrates another embodiment of an optoelectronic device; and

FIG. 21 illustrates a problem with a related-art device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

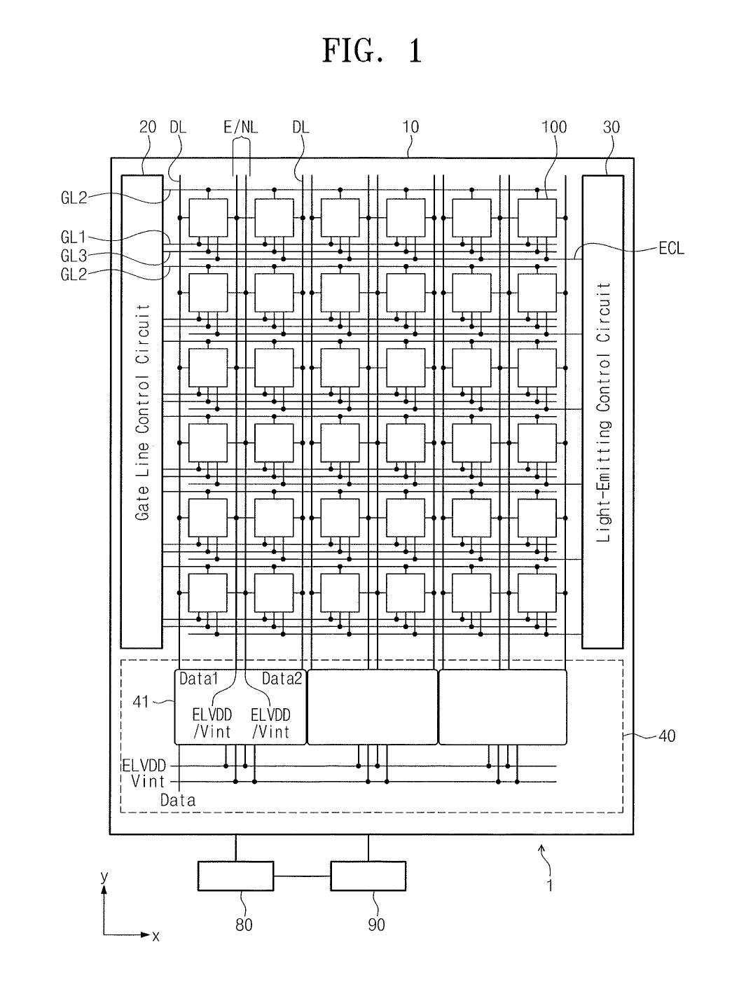

FIG. 1 illustrates an embodiment of an electronic device, which, for example, may be a smart phone, a handheld telephone, a personal computer, or a television. The electronic device 1 has a display unit which includes an optoelectronic device 10, a control unit 80, and a power supply unit 90. The optoelectronic device has pixels 100 arranged in a matrix. The pixels emit light from current light-emitting elements of the pixels 100 to generate images.

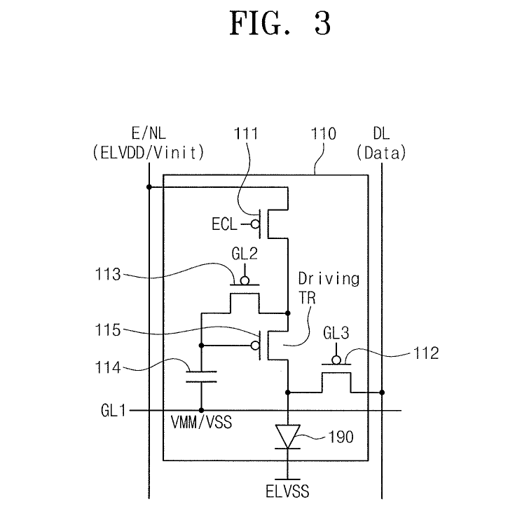

Each pixel 100 has a pixel circuit 110 (e.g., refer to FIG. 3) and a current light-emitting element 190, which, for example, is a light-emitting element using organic EL. In another embodiment, the light-emitting element may be another type of light-emitting element, e.g., one in which the strength of light-emitting varies with the amount of supplied current.

In FIG. 1, the pixels 100 are arranged in a 6-by-6 matrix. A different arrangement and/or number of pixels 100 may be provided in other embodiments. Below, embodiments are described under the assumption that the pixels 100 are arranged in an i-by-j matrix.

The control unit 80 includes a central processing unit (CPU) and a memory. The control unit 80 may be a controller that controls an operation of the optoelectronic device 10. The control operation of the control unit 80 may include an operation of controlling the current light-emitting element 190 of each pixel 100 to emit light. This may be achieved by determining a gray scale value of each pixel 100 depending on image data indicating an image to be displayed on a display unit of the electronic device 1, and writing a data voltage corresponding to the gray scale value at the pixel circuit 110. The power supply unit 90 powers components of the electronic device 1 including the optoelectronic device 10, the control unit 80, and so on.

The optoelectronic device 10 includes pixels 100 arranged in a matrix, a gate line control circuit 20 a light-emitting control circuit 30, a power supply line and data line control circuit 40, power supply lines E/NL, light-emitting control lines ECL, data lines DL, and a plurality of gate lines GL.

The gate line control circuit 20 supplies a control signal to each of a plurality of gate lines GL1, GL2, and GL3 that are implemented to correspond to each row of pixels 100. As will be described later, two signals VMM and VSS are supplied to the gate line GL1 with a predetermined timing. The gate line GL1 enables a driving transistor 115 to be turned off or on. A control signal G2 is provided to the gate line GL1, to turn on or off a switching transistor 113. A control signal G3 is provided to the gate line GL3, to turn on or off a write control transistor 112.

The light-emitting control circuit 30 supplies an light-emitting/initialization signal EM to control light-emitting or initialization of a gate voltage of a driving transistor. The signal EM is supplied through a light-emitting control line ECL provided to correspond to each row of pixels 100.

The power supply line and data line control circuit 40 provides a data line DL with a data voltage corresponding to gray scale to be displayed at each pixel. A high voltage ELVDD is supplied to the power supply line E/NL as a source of current, which is to be supplied to the current light-emitting element 190. A voltage Vinit for initializing a gate voltage of a driving transistor, in turn every horizontal period, is also supplied through the power supply line E/NL.

The display unit of the optoelectronic device 10 includes an area in which the gate line control circuit 20, the light-emitting control circuit 30, and the power supply line and data line control circuit 40 are located. The power supply lines E/NL extend in a vertical direction of the display unit, and two power supply lines E/NL are disposed between two adjacent columns of pixels 100. The pixels 100 in two adjacent columns are connected to two power supply lines E/NL (e.g., a set of power supply lines E/NL or a power supply line set) alternately every row.

For example, the power supply line include a first power supply line and a second power supply line which are connected to even-numbered or odd-numbered pixel circuits in two adjacent columns, respectively. In one embodiment, power supply lines E/NL are between two columns of pixels 100. In another embodiment, if two power supply lines E/NL are disposed every two adjacent columns of pixels 100, the arrangement is not limited to relationship with two adjacent columns of pixels 100. In the event that power supply lines E/NL are between two adjacent columns of pixels 100, it is possible to make a length of a line, connecting each pixel 100 to a power supply line E/NL, short, thereby reducing unnecessary parasitic capacitance.

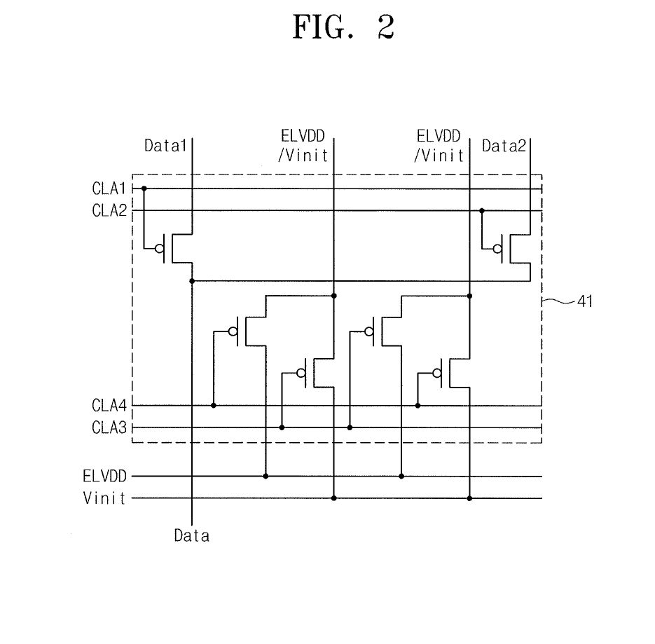

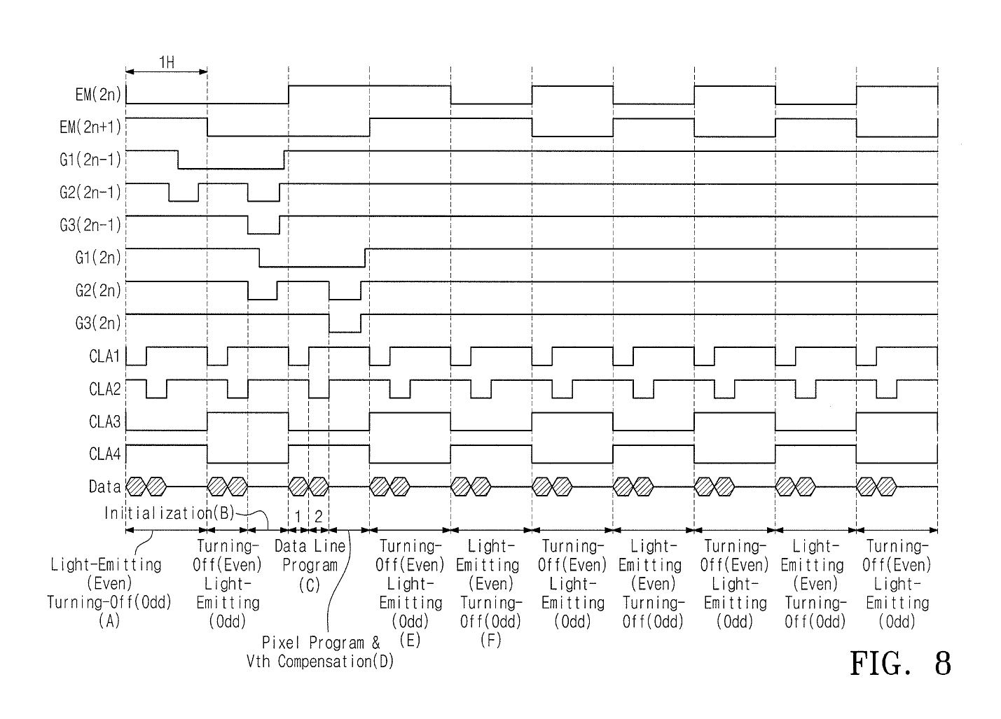

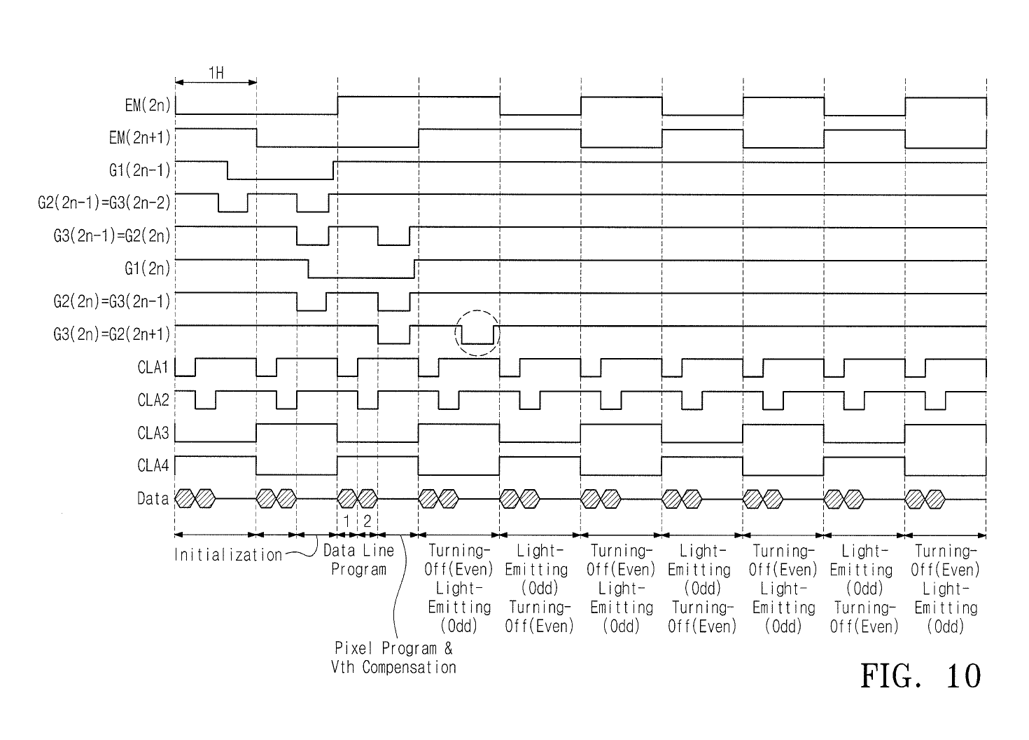

FIG. 2 illustrates an embodiment of a de-multiplexor 41 which has a plurality of blocks corresponding to two columns of pixels 100, and which operates in response to control signals CLA1, CLA2, CLA3, and CLA4 supplied under a control of a control unit 80. As illustrated in FIG. 8 or 10, the de-multiplexor 41 supplies a data voltage to a data line DL in response to the control signals CLA1 and CLA2 and ELVDD or Vinit to one of a set of power supply lines in response to the control signals CLA3 and CLA4.

FIG. 3 illustrates an embodiment of a pixel circuit 110 in each pixel 100. The pixel circuit 110 includes a current light-emitting element 190, a power supply control transistor 111, a write control transistor 112, a switching transistor 113, a driving transistor 115, and a capacitive element 114. All transistors in the pixel circuit 110 are p-type transistors. In this case, precise control is possible because electron mobility of a p-type transistor is lower than that of an n-type transistor.

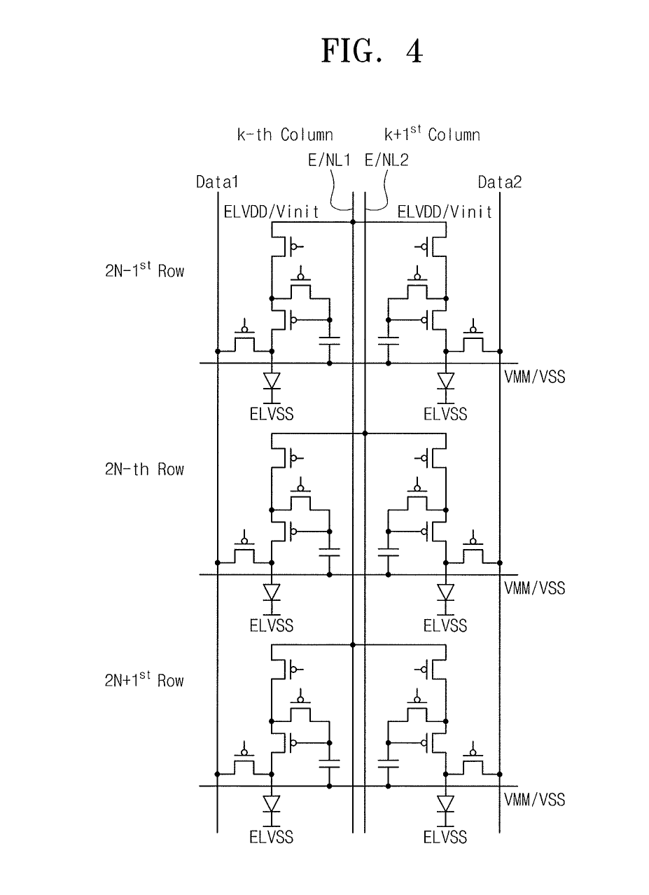

The pixel circuit 110 is connected to one of a set of power supply lines E/NL, a plurality of gate lines GL1, GL2, and GL3, a light-emitting control line ECL, a data line DL, and a low potential ELVSS. As illustrated in FIG. 4, if a set of power supply lines E/NL1 and E/NL2 are arranged between adjacent K-th and K+1st columns of pixels 100 in a matrix, pixel circuits 110 of pixels 100 at the 2N−1st row and K-th column and the 2N−1st row and K+1st column are connected to the power supply line E/NL1. The pixel circuits 110 are connected to one of a set of power supply lines in right and left alternation every row.

Referring to FIG. 3, the pixel circuit 110 is connected to the power supply line E/NL. A power supply control transistor 111, a driving transistor 115, and a current light-emitting element 190 are connected sequentially from a power supply line (E/NL) side on a path through which the power supply line E/NL and the low potential ELVSS are connected. A gate of the power supply control transistor 111 is connected to a light-emitting control line ECL. A gate of the write control transistor 112 is connected to a gate line GL3, and a first terminal (source or drain) and a second terminal (drain or source) of the write control transistor 112 are connected to a data line DL and the current light-emitting element 190, respectively. As will be described in detail later, the capacitive element 114 has one terminal connected to a gate line GL1 for transferring VSS or VMM and another terminal connected to a gate of the driving transistor 115. A switching transistor 113 has a gate connected to a gate line GL2, a first terminal connected to the capacitive element 114, and a second terminal connected to a first terminal (source or drain) of the driving transistor 115.

Elements of the pixel circuit 110 and their operation will now be described.

### Write Control Transistor 112

The write control transistor 112 controls the supply a data voltage through the data line DL in response to a control signal G3 from the gate line GL3. The data voltage is based on grayscale value of light to be displayed at each pixel, and is determined within a range where the current light-emitting element 190 turns off Consider, for example, the case where a low potential is denoted by ELVSS and a light-emitting threshold voltage of the current light-emitting element 190 is denoted by Vth_E. Then, the data voltage may be determined such that a difference between ELVSS and the data voltage is smaller than Vth_E.

Operation of the pixel circuit 110 will now be more fully described. Before the data voltage is written at the pixel circuit 110, a voltage of the capacitive element 114 is initialized, when Vinit is supplied to one terminal of the capacitive element 114 from the power supply line E/NL and VSS is supplied to the other terminal thereof from the gate line GL1. Thus, the driving transistor 115, formed of a p-type transistor, is turned on before the data voltage is written. Also, when the switching transistor 113 is turned on in response to the control signal G2 from the gate line GL2, the data voltage is supplied to the capacitive element 114.

### Power Supply Control Transistor 111

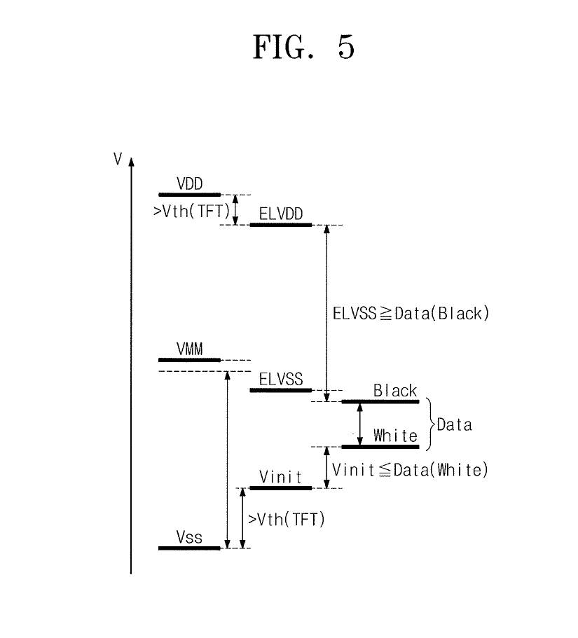

The power supply control transistor 111 is connected to the power supply line E/NL and controls supply of ELVDD or Vinit to the pixel 100 in response to a light-emitting/initialization signal EM transferred through the light-emitting control line ECL.ELVDD is supplied to the first terminal of the driving transistor 115 through the power supply control transistor 111. ELVDD may be a gate voltage of the driving transistor 115, that is, a voltage (refer to FIG. 5) higher than a voltage that the capacitive element 114 holds. Hence, the driving transistor 115 is turned on. At this time, current is supplied to the current light-emitting element 190 depending on the voltage held by the capacitive element 114, that is, the gate voltage of the driving transistor 115.

When Vinit is supplied to the first terminal of the switching transistor 113 through the power supply control transistor 111, the switching transistor 113 is turned on in response to the control signal G2 of the gate line GL2, thereby supplying Vinit to the capacitive element 114. As VSS is provided to the gate line GL1, the gate voltage of the driving transistor 115, that is, the voltage held by the capacitive element 114, is initialized.

### Driving Transistor 115

The driving transistor 115 has a first terminal connected to the second terminal of the power supply control transistor 111 and the first terminal of the switching transistor 113, a second terminal connected to the current light-emitting element 190, and a gate connected to the capacitive element 114.

The driving transistor 115 controls current to be supplied to the current light-emitting element 190 depending on a voltage held by the capacitive element 114. As described above, the capacitive element 114 holds a voltage corresponding to gray scale to be displayed at each pixel 100. When the power supply control transistor 111 is turned on in response to an emitting/initialization signal EM, the driving transistor 115 may receive ELVDD through the power supply control transistor 111 and supplies current to the current light-emitting element 190 depending on a voltage held by the capacitive element 114.

### Switch Transistor 113

When turned on in response to the control signal G2 supplied through the gate line GL2, as described above, the switch transistor 113 supplies Vinit to the capacitive element 114 at timing when Vinit is supplied to the first terminal. When turned off in response to the control signal G2 supplied through the gate line GL2, the switching transistor 113 does not provide ELVDD to the capacitive element 114 at timing when ELVDD is provided to the first terminal. As a result, it is possible to supply current to the current light-emitting element 190 depending on a voltage held by the capacitive element 114.

### Current Light-Emitting Element 190

The current light-emitting element 190 has a first terminal connected to the second terminal of the driving transistor 115 and a second terminal connected to ELVSS. The current light-emitting element 190 emits light based on an amount of current supplied through the driving transistor 115.

### Relationship among Potentials

A relationship among a high voltage ELVDD, a low voltage ELVSS, an initialization voltage Vinit, VSS and VMM supplied to a gate line GL1, and a data voltage Data is illustrated in FIG. 5. VSS is low as described above, and the data voltage Data includes a voltage range lower than a light-emitting threshold voltage of the current light-emitting element 190 and is decided depending on the grayscale value.

### Operation

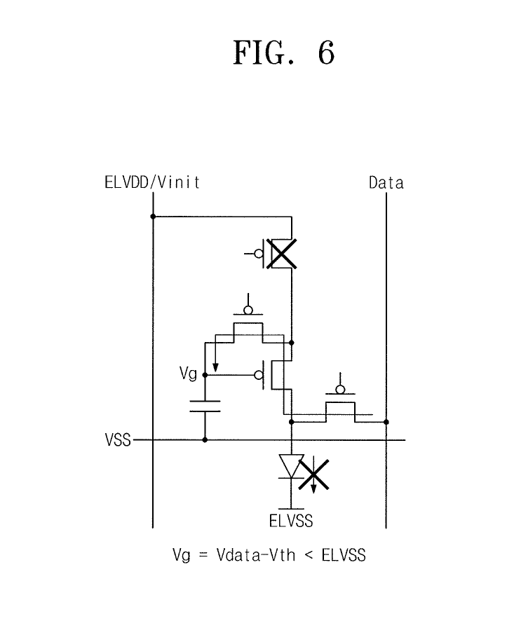

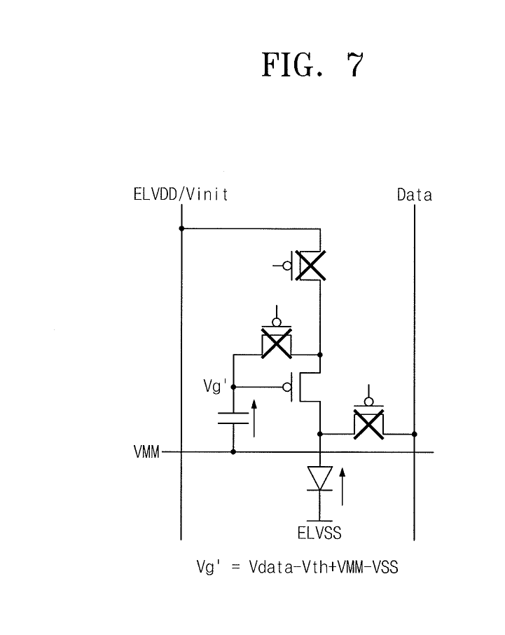

When controlling current for driving the current light-emitting element 190, a problem may arise when a data voltage is written. For example, a threshold voltage of the driving transistor 115 may vary when a data voltage is written. However, variation in the threshold voltage of the driving transistor 115 may be corrected by conducting an operation such as in FIGS. 6 and 7.

In FIG. 6, VSS is supplied to the gate line GL1. A data voltage Vdata supplied to the data line DL is supplied to the capacitive element 114 by turning on the transistors 112, 113, and 115 and turning off the transistor 111 during T1. At this time, a voltage supplied to the capacitive element 114, that is, a gate voltage Vg of the driving transistor 115 may be determined by Equation (1).

Vg=Vdata−Vth-<ELVSS (1)

After T1 elapses, during T2, as illustrated in FIG. 7, the write control transistor 112 and the switching transistor 113 are turned off, and VMM is supplied to the gate line GL1. In this case, Vg is boosted as expressed by Equation (2).

Vg¹=Vdata−Vth+VMM−VSS (2)

As described above, a variation in a threshold voltage of the driving transistor 115 is corrected.

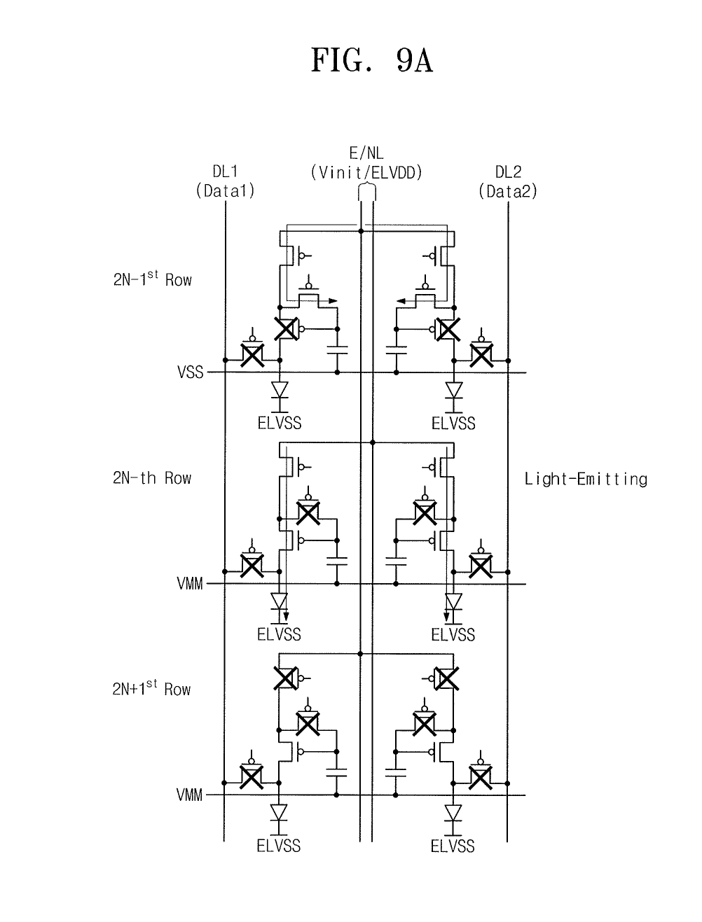

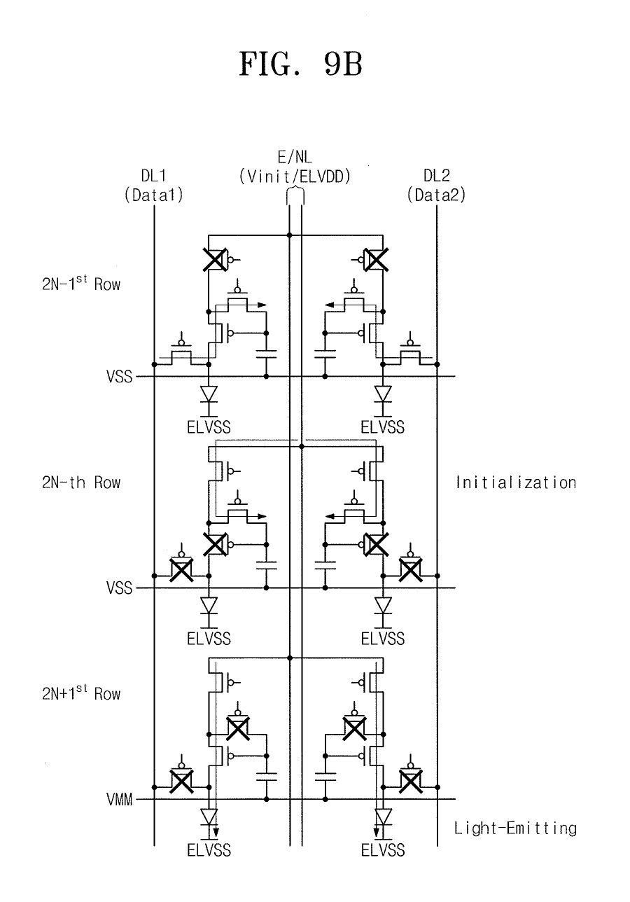

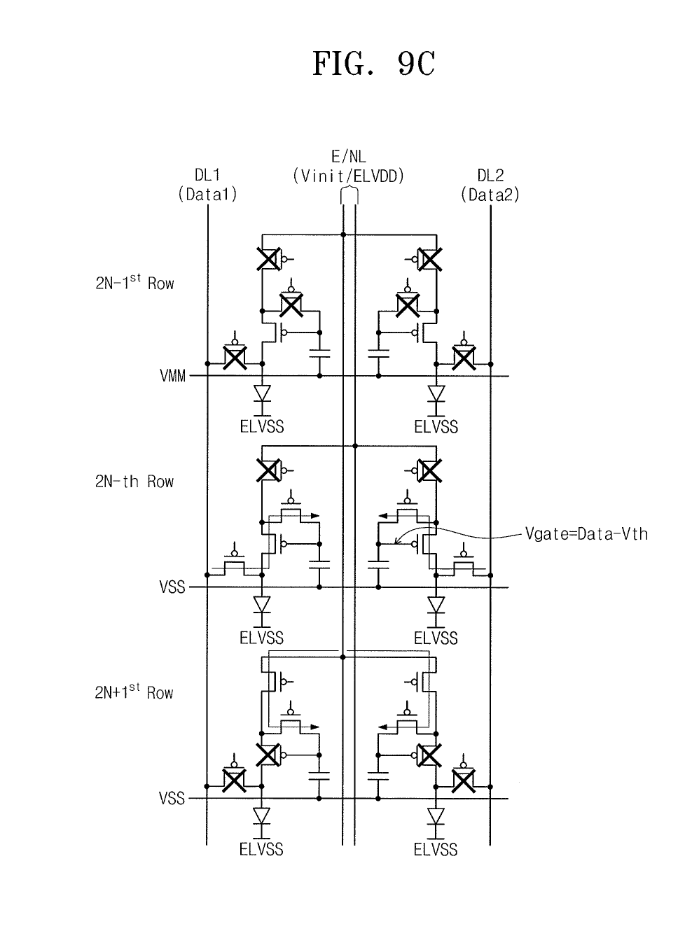

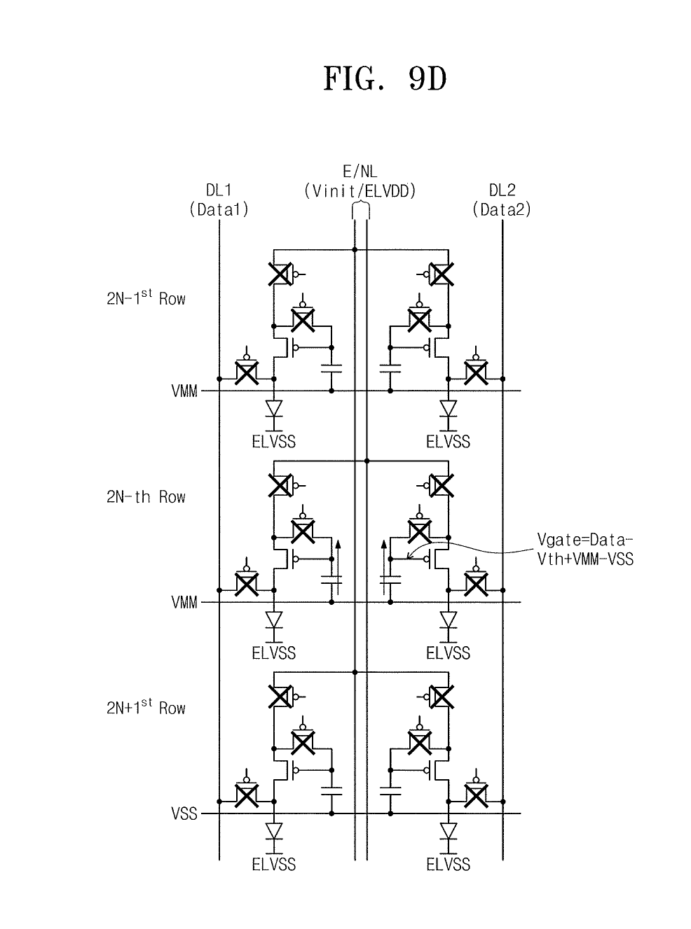

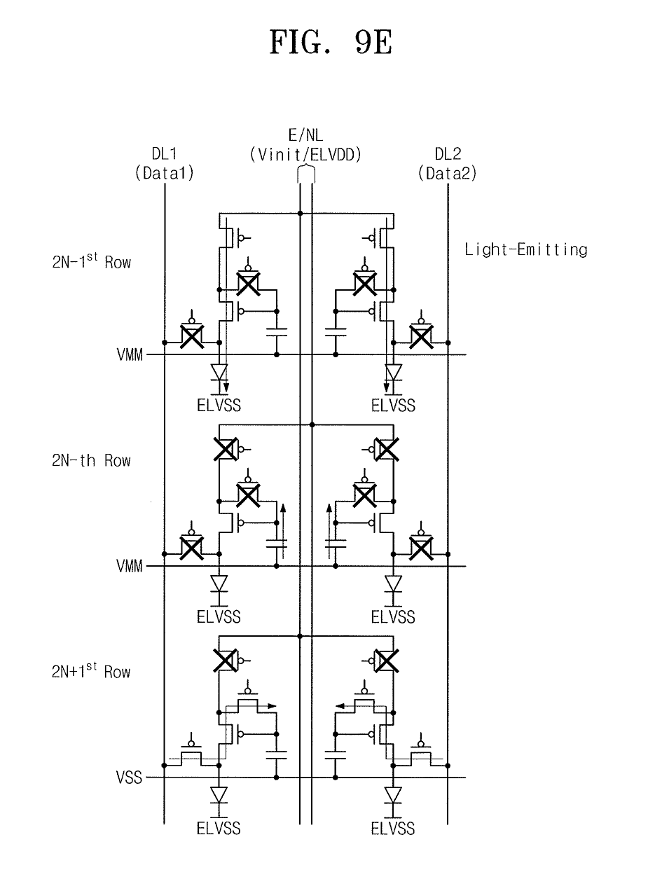

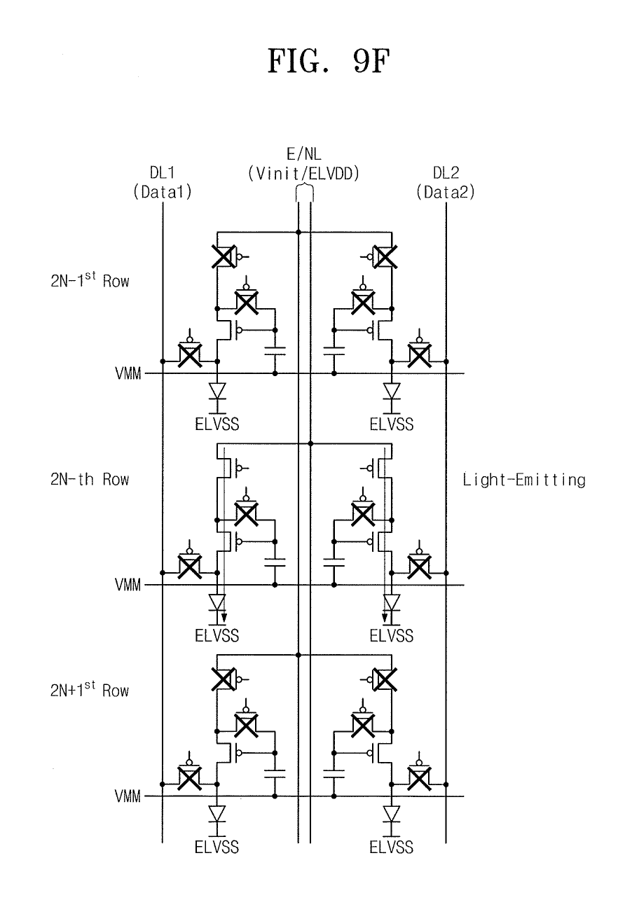

FIG. 8 illustrates timing of signals associated with pixel circuits 110 of 2N-1st through 2N+1st rows according to one embodiment. FIGS. 9A through 9F indicate states of pixel circuits 110 at the 2N-th row and K-th and K+1st columns and at the 2N−1st and 2N+1st rows. Herein, ‘2N’ and ‘K+1st’ are even numbers. Thus, the 2N-th row is an even-numbered row, and the 2N+1st and 2N−1st rows are odd-numbered rows.

As described above, a set of power supply lines may be disposed every two columns of pixel circuits 110. However, since pixel circuits 110 in two columns are connected to one of the set of power supply lines alternately every row, pixel circuits 110 in even-numbered rows are connected to the same power supply line and pixel circuits 110 in odd-numbered rows are connected to the same power supply line.

Herein, ELVDD and Vinit are alternately supplied to the set of power supply lines every horizontal period. Thus, when ELVDD is supplied to pixel circuits 110 in even-numbered rows, Vinit is supplied to pixel circuits 110 in odd-numbered rows. Also, in FIG. 8, (2n), (2n−1), etc. attached to signal names denote signals to be supplied to a 2N-th row, a 2N-1st row, etc. For example, EM(2n) indicates an emitting/initialization signal EM to be supplied to a 2N-th row.

In FIG. 8, 1H indicates one horizontal scan period, and FIGS. 9A to 9F correspond to sections (A) to (F) of FIG. 8, respectively. Unlike data voltage Data, each signal has a high-level voltage or a low-level voltage. In exemplary embodiments, p-type transistors are used which turn on when a low-level voltage is applied to a gate electrode of the transistor. Also, in FIG. 8, sections (A) through (F) are described with reference to FIGS. 9A to 9F, with operation of a pixel circuit 110 of a 2N-th row being an even-numbered row as the center.

Referring to FIG. 9A, ELVDD is supplied to a power supply line E/NL2 to which the pixel circuit 110 of the 2N row is connected. First, in a section corresponding to FIG. 9A, since a high-level control signal is supplied to gate lines GL2 and GL3 of the pixel circuit 110 of the 2N-th row, a switching transistor 113 and a write control transistor 112 of the pixel circuit 110 of the 2N-th row are turned off. Now that a power supply control transistor 111 is turned on in response to a low-level signal EM applied to a light-emitting control line ECL of the pixel circuit 110 of the 2N-th row, ELVDD is supplied from the power supply line E/NL2 to a driving transistor 115.

When VMM is supplied to a gate line GL1 of the pixel circuit 110 of the 2N-th row, a voltage of a capacitive element 144 is boosted as high as VMM, thereby turning on the driving transistor 115. In this case, a current light-emitting element 190 emits light because current corresponding to a voltage of the capacitive element 114 is supplied to the current light-emitting element 190.

Since Vinit is supplied to a power supply line E/NL1, pixel circuits 110 at the 2N—1st and 2N+1st rows (odd-numbered rows) are turned off, and the pixel circuit 110 at the 2N-1st row is initialized.

During a section corresponding to FIG. 9B, Vinit is supplied to the power supply line E/NL2 to which a pixel circuit 110 at the 2N-th row is connected. A write control transistor 112 of the pixel circuit 110 at the 2N-th row is turned off because a high-level control signal is applied to a gate line GL3 of the pixel circuit 110 at the 2N-th row. The switching transistor 113 is turned on because a low-level control signal G2 is applied to a gate line GL2 of the pixel circuit 110 at the 2N-th row. Now that the power supply control signal 111 is turned on in response to a low-level signal EM applied to the light-emitting control line ECL of the pixel circuit 110 at the 2N-th row, Vinit supplied to the power supply line E/NL2 is provided to the capacitive element 114. Afterwards, VSS is supplied to a gate line GL1, a voltage of the capacitive element 114 is initialized.

In pixel circuits 110 at the 2N−1st and 2N+1st rows (odd-numbered rows), ELVDD is supplied to the power supply line E/NL1. A data voltage is written in the pixel circuit 110 at the 2N-1th row with a power supply control transistor turned off Unlike pixel circuits 110 at the 2N-1st row where data voltages are being written, pixel circuits 110 in odd-numbered rows emit light.

In a section corresponding to FIGS. 9C and 9D, ELVDD is supplied to the power supply line E/NL2 to which the pixel circuit at the 2N-th row is connected. However, the power supply control transistor 11 is turned off in response to a high-level signal EM applied to the light-emitting control line ECL of the pixel circuit 110 at the 2N-th row. Data1 on a data line DL1 and Data2 on a data line DL2 are respectively supplied to the pixel circuit 110 at the 2N-th row and K-th column and to the pixel circuit 110 at the 2N-th row and K+1st column through the write control transistors 112, which are turned on by a low-level control signal G3 provided from the gate line GL3.

As described above, since a voltage of the capacitive element 114 of the pixel circuit 110 at the 2N-th row has been initialized, the p-type driving transistor 115 is at an on state before a data voltage is written. Also, as the switching transistor 113 of the pixel circuit 110 at the 2N-th row is turned in response to a low-level control signal provided through the gate line GL2, Data1 and Data2 are supplied to the capacitive elements 114 of corresponding pixel circuits 110. For example, writing of the data voltage is completed.

The capacitive element 114 holds a voltage corresponding to gray scale to be displayed at a display unit. More specifically, the capacitive element 114 holds a voltage of (Data1/Data2-Vth), where Vthis the threshold voltage of the driving transistor 115. Pixel circuits 110 of even-numbered rows except the pixel circuit 110 at the 2N-th row may emit light.

In pixel circuits 110 at the 2N−1st and 2N+1st rows (odd-numbered rows), Vinit is supplied to the power supply line E/NL1. The pixel circuit 110 at the 2N+1st is initialized.

Afterwards, as illustrated in FIG. 9D, a voltage on the data line DL1 transitions from VSS to VMM, a voltage of the capacitive element 114 of the pixel circuit 110 at the 2N-th row is boosted as high as (VMM-VSS), and a variation in a threshold voltage of the driving transistor 115 is corrected. In the pixel circuit 110 at the 2N-th row and K-th column, a voltage Vgate held by the capacitive element 114 is boosted from a voltage (Data1-Vth) as high as a voltage of (VMM-VSS). In the pixel circuit 110 at the 2N-th row and K-1st column, a voltage Vgate held by the capacitive element 114 is boosted from a voltage (Data2-Vth) as high as a voltage of (VMM-VSS). Equation (3) indicates a voltage Vgate thus decided.

Vgate=Data−Vth+VMM−VSS (3)

In a section corresponding to FIG. 9E, Vinit is supplied to the power supply line E/N2 to which the pixel circuit 110 at the 2N-th row is connected. The power supply control transistor 111, the write control transistor 112, and the switching transistor 113 of the pixel circuit 110 at the 2N-th row are turned off because control signals G1 through G3 supplied to the gate lines GL1 through GL3 are have a high level. This means that the pixel circuit 110 at the 2N-th row is turned off. Also, pixel circuits 110 at any other even-numbered rows may be turned off.

In a section corresponding to FIG. 9E, ELVDD is provided to the power supply line E/NL2 to which the pixel circuit 110 at the 2N+1st or 2N−1st row is connected. The pixel circuit 110 at the 2N+1st row conducts an operation of writing a data voltage, while the pixel circuit 110 at an odd-numbered row emits light.

During a section corresponding to FIG. 9F, ELVDD is applied to the power supply line E/NL2 to which the pixel circuit 110 at the 2N-th row is connected. Herein, the capacitive element 114 of the pixel circuit 110 at the 2N-th row may hold a voltage corresponding to gray scale value of light to be displayed at the display unit through an operation described with reference to sections corresponding to FIGS. 9C and 9D.

Since a low-level signal EM is supplied through the light-emitting control line ECL and a high-level control signal is applied to the gate lines GL3 and GL2, the write control transistor 112 and the switching transistor 113 of the pixel circuit 110 at the 2N-th row are all turned off. On the other hand, the power supply control transistor 111 is turned on. Thus, ELVDD is provided to the first terminal of the driving transistor 115 through the power supply control transistor 111 of the pixel circuit 110 at the 2N-th row.

Now that ELVDD to be supplied to the first terminal of the driving transistor 115 of the pixel circuit 110 at the 2N-th row is set to be higher than a voltage held by the capacitive element 114 (refer to FIG. 5), the driving transistor 115 is turned on. This makes it possible for the driving transistor 115 to provide the current light-emitting element 190 with a current corresponding to a voltage held by the capacitive element 114. The current light-emitting element 190 of the pixel circuit 110 at the 2N-th row emits light with luminance corresponding to the amount of current. Also, the pixel circuit 110 at the 2N+2nd row (even-numbered row) conducts an operation of writing a data voltage, while the pixel circuit 110 of an even-numbered row emits light.

During a section corresponding to FIG. 9F, Vinit is supplied to the power supply line E/NL2 to which the pixel circuit 110 at the 2N+1st or 2N−1st row is connected. Thus, pixel circuits 110 of all odd-numbered rows including the pixel circuits 110 at the 2N+1st and 2N−1st rows are turned off.

A sequence of operations of an optoelectronic device may be described based on operation of the pixel circuit 110 at the N-th row as the center. After the above-described operations, states corresponding to FIGS. 9E and 9F are repeated until a next data voltage is written.

### Second Embodiment

FIG. 10 illustrates an embodiment of a timing diagram of signals associated with pixel circuits 110 at the 2N−1st through 2N+1st rows according to a second embodiment.

As illustrated in FIG. 10, in the event that a low-level control signal G3 is supplied to a gate line GL3 at the 2N-th row in any one horizontal period, and then is supplied the same in a sequent 1 horizontal period (refer to a circle of FIG. 10), a control signal of a gate line GL2 at the 2N-th row in 2 horizontal period has the same waveform as a control signal of a gate line GL3 at the 2N−1st row in 2 horizontal period. This makes it possible to share a control signal G2 of the gate line GL2 at the 2N-th row and a control signal G3 of the gate line GL3 at the 2N−1st row. Thus, the gate driver 20 may be simplified, and the gate lines GL2 and GL3 may be simplified by one gate line.

Supplying a low-level control signal G3 to a gate line GL3 at the 2N-th row in any one horizontal period, and then supplying the same in a sequent 1 horizontal period, presents no problem. Since the pixel circuit 110 of an even-numbered row is turned off due to a supply of Vinit, the current light-emitting element 190 does not emit light, even though a data voltage is supplied to the pixel circuit 110 through the write control transistor 112 turned on by the control signal G3.

### Third Embodiment

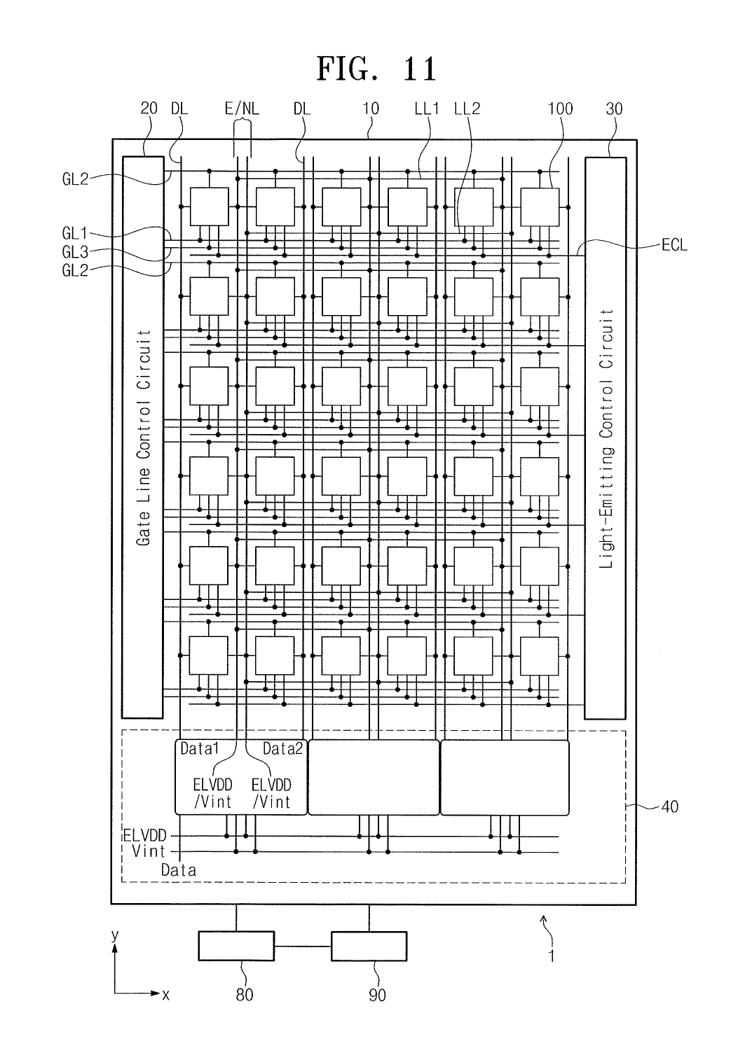

FIG. 11 illustrates another embodiment of an optoelectronic device 10, where in a plurality of sets of power supply lines E/NL1 and E/NL2, power supply lines supplied with ELVDD during 1 horizontal period are connected to a first line LL1 extending in a horizontal direction, and power supply lines supplied with Vinit during 1 horizontal period are connected to a second line LL2 extending in the horizontal direction. With this configuration, for example, the power supply lines are implemented in a mesh shape. Thus, it is possible to reduce crosstalk. For example, the crosstalk may arise when a voltage drop variation between power supply lines is generated depending on the amount of current flowing into a current light-emitting element of each pixel circuit 110 connected to the power supply lines.

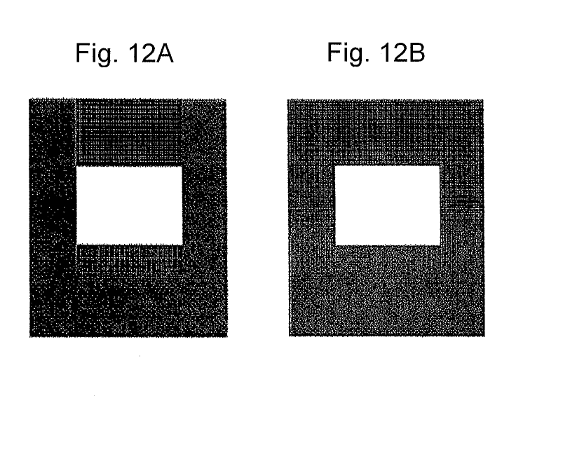

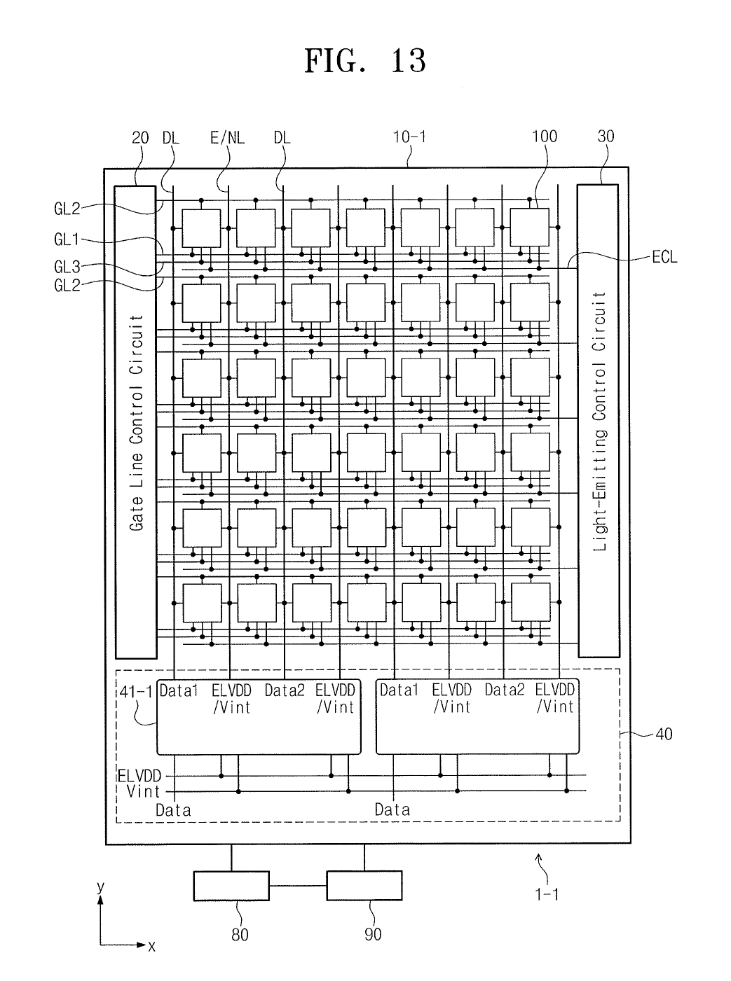

FIG. 12A illustrates an image when a white window is displayed on a gray background of the whole screen in an optoelectronic device 10 according to a first embodiment. FIG. 12B illustrates an image when a white window is displayed on a gray background of the whole screen in an optoelectronic device 10 according to a third embodiment.

In the optoelectronic device 10 according to the first embodiment, a power supply line E/NL is disposed only in a longitudinal direction. Thus, if a white window is displayed, upper and lower pixels may experience great voltage drop, thereby making the upper and lower pixels dark compared with left and right pixels.

In the case the optoelectronic device 10 according to the third embodiment, since power supply lines E/NL are arranged in a mesh shape, upper and lower edges of the while window are faint, thereby making it possible to put crosstalk (unevenness) in the shape. It is possible to combine the first through third embodiments. In this case, a combined embodiment may have the same effects as the first through third embodiments.

### Fourth Embodiment

FIG. 13 illustrates an electronic device 1-1 according to a fourth embodiment. The fourth embodiment of the electronic device 1-1 is the same as the first through third embodiments, except for arrangement of power supply lines E/NL.

In the first through third embodiments, two power supply lines are between two adjacent columns of pixels 100. In contrast, the electronic device 1-1 according to the fourth embodiment is implemented such that one power supply line E/NL is disposed between two adjacent columns of pixels 100. That is, in the electronic device 1-1 according to the fourth embodiment, pixels 100 in two adjacent columns are connected to the same power supply line E/NL.

In this embodiment, the power supply line E/NL is disposed between two adjacent columns of pixels 100. However, if one power supply line is disposed every two adjacent columns of pixels 100, the arrangement is not limited to a relation with two adjacent columns of pixels 100. In the event that the power supply line E/NL is disposed between two adjacent columns of pixels 100, the length of a line for connecting each pixel 100 to the power supply line E/NL may be shortened, thereby reducing unnecessary parasitic capacitance.

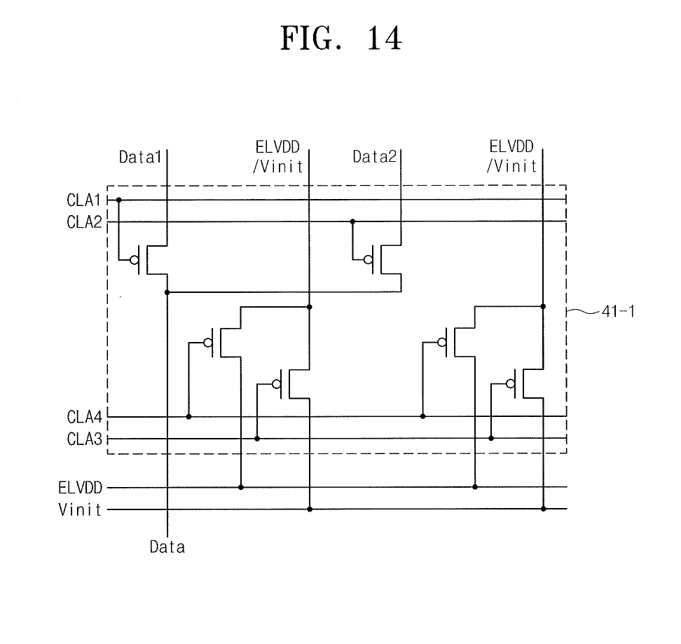

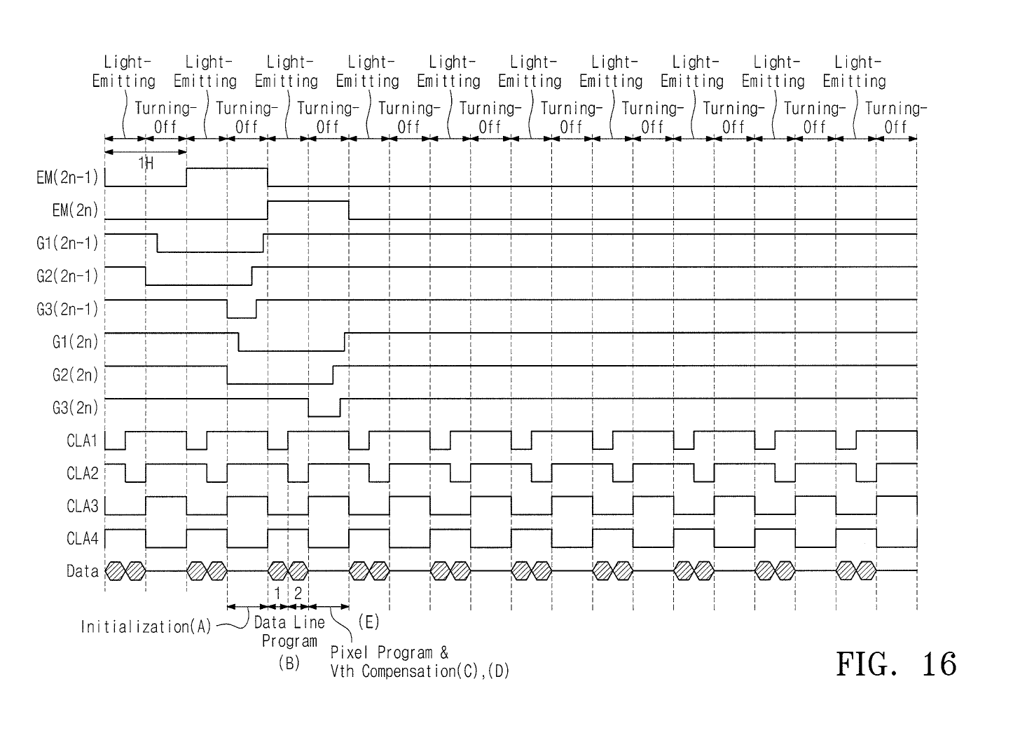

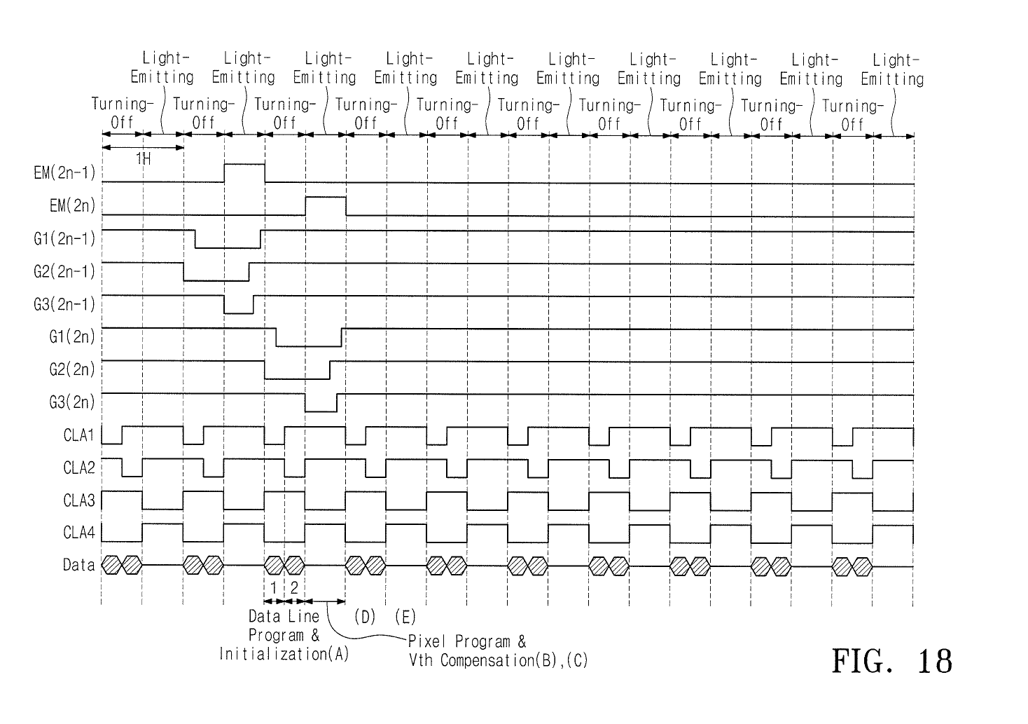

FIG. 14 illustrates an embodiment of a de-multiplexor 41-1 according to the fourth embodiment. The de-multiplexor 41-1 has a plurality of blocks corresponding to two columns of power supply lines E/NL and operates in response to control signals CLA1, CLA2, CLA3, and CLA4 supplied under a control of a control unit 80. As illustrated in FIG. 16 or 18, the de-multiplexor 41-1 supplies a data voltage to a data line DL in response to the control signals CLA1 and CLA2 and ELVDD or Vinit to one of a set of power supply lines in response to the control signals CLA3 and CLA4.

Also, in FIGS. 16 and 18, the control signals CLA1 and CLA2 are supplied every section corresponding to a quarter of one horizontal scan period, thereby making it possible to reduce the number of lines for transferring data voltages between the control unit 80 and the de-multiplexor 41-1. In another embodiment, the control signals CLA1 and CLA2 for controlling data lines DL1 and DL2 such that they are supplied every section corresponding to half the one horizontal scan period.

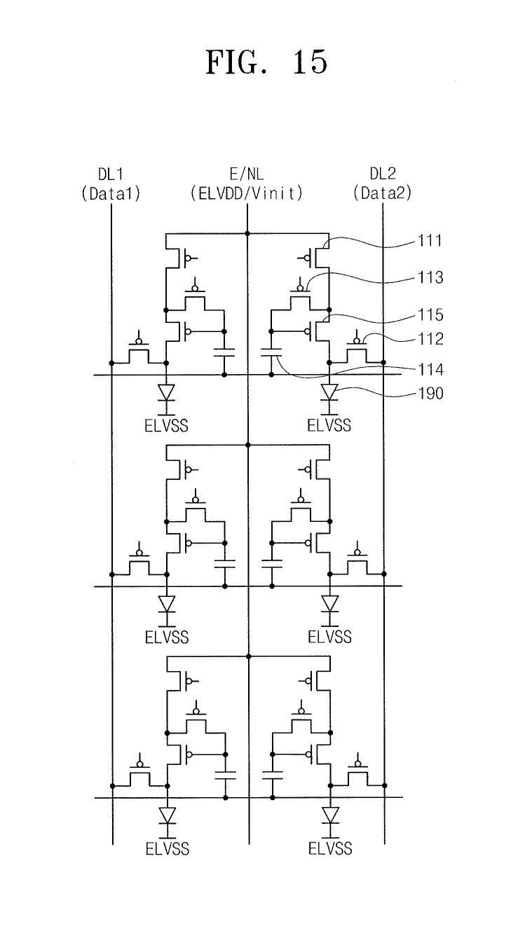

FIG. 15 illustrates an embodiment of a pixel circuit of each pixel 100 according to a fourth embodiment. A pixel circuit 110 may be substantially the same as those according to first through third embodiments.

The pixel circuit 110 is connected to a power supply line E/NL, a plurality of gate lines GL1, GL2, and GL3, a light-emitting control line ECL, a data line DL, and a low potential ELVSS. Transistors 111, 112, 113, and 115, a capacitive element 114, and a current light-emitting element 190 constituting the pixel circuit 110, the power supply line E/NL, the gate lines GL1 through GL3, the light-emitting control line ECL, the data line DL, and the low potential ELVSS are connected substantially the same as those according to the first through third embodiments. Thus, components of the pixel circuit 110 according to the fourth embodiment may operate the same as those according to the first through third embodiments. Also, the relationship among a high potential ELVDD, a low potential ELVSS, an initialization voltage Vinit, VSS and VMM supplied to a gate line GL1, a data voltage Data is substantially the same as that according to the first through third embodiments.

FIG. 16 illustrates timing of signals associated with pixel circuits 110 of 2N−1st through 2N+1st rows according to one embodiment. In FIG. 16, (A) through (E) indicate states of pixel circuits 110 at the 2N-th, 2N−1st, and 2N+1st rows. Herein, ‘2N’ indicates an even number. Thus, the 2N-th row is an even-numbered row, and the 2N+1st and 2N−1st rows are odd-numbered rows.

As described above, since a power supply line may be disposed every two adjacent columns of pixel circuits 110, pixels 110 of two adjacent columns are connected to the same power supply line. Also, in FIG. 16, (2n), (2n−1), etc. attached to signal names denote signals to be supplied to a 2N-th row, a 2N−1st row, etc. For example, EM(2n) indicates a light-emitting control signal EM to be supplied to a 2N-th row.

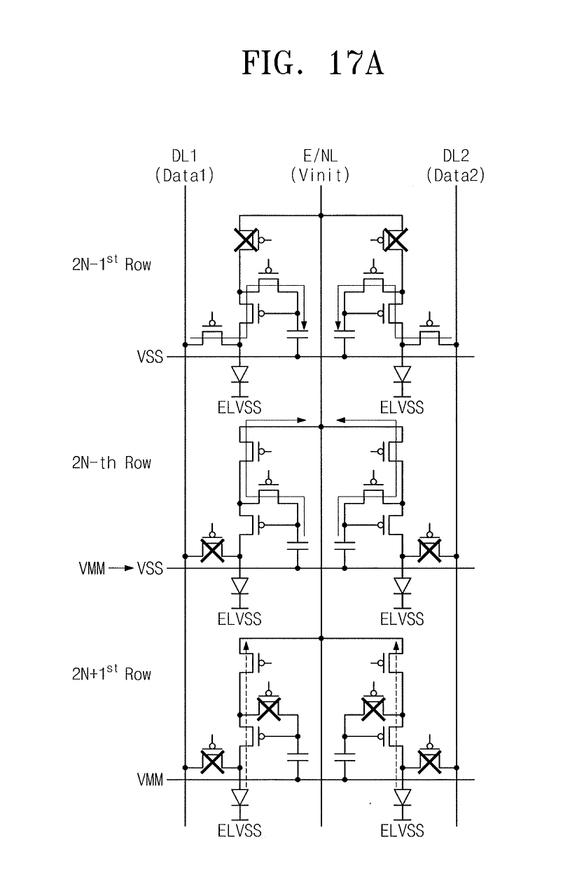

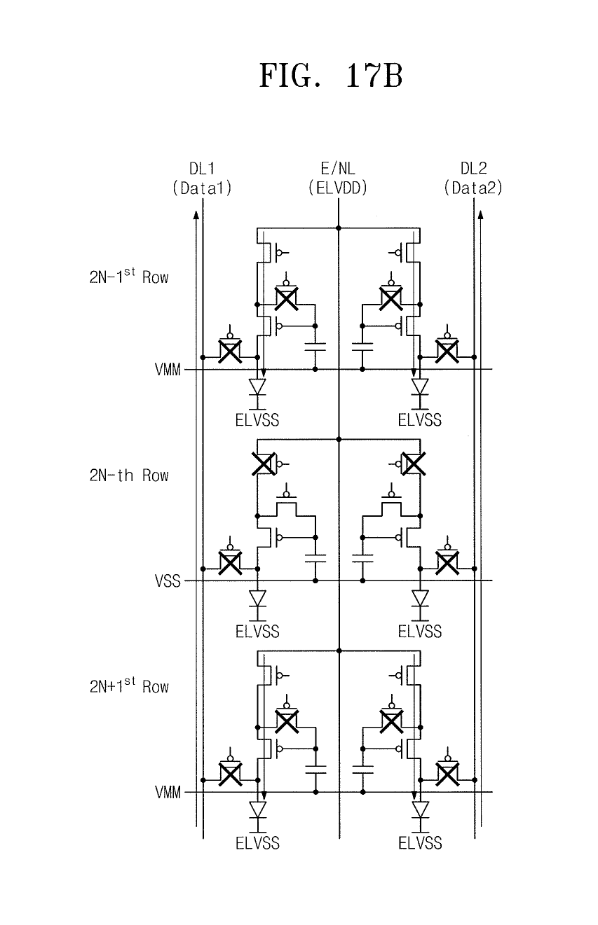

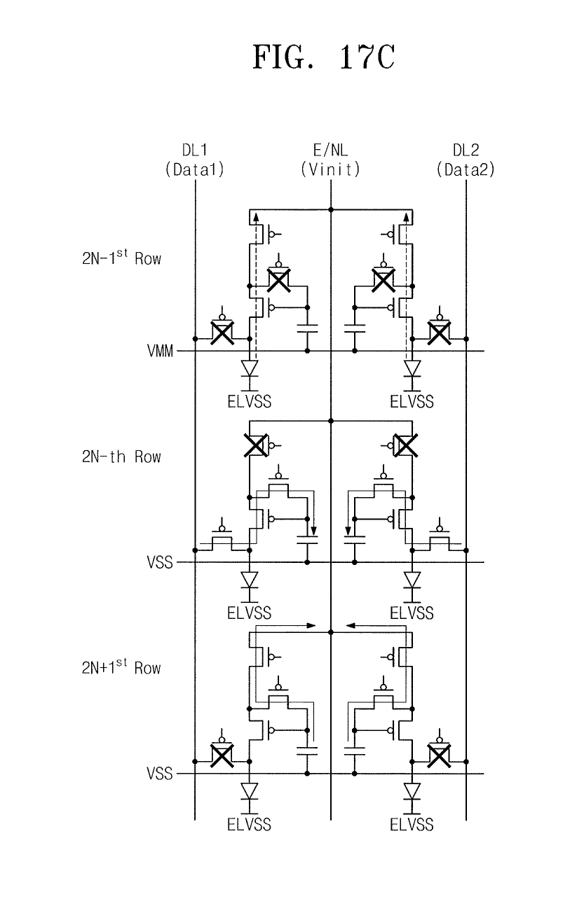

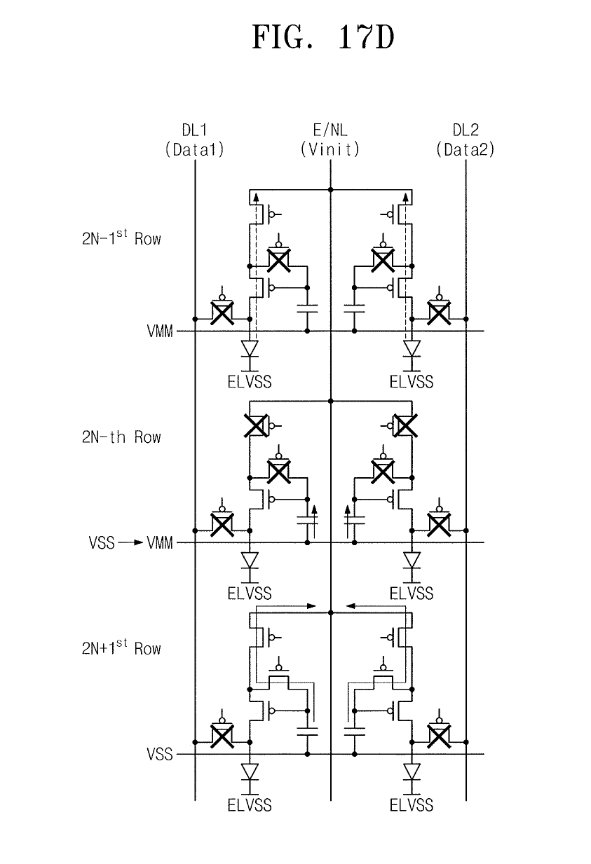

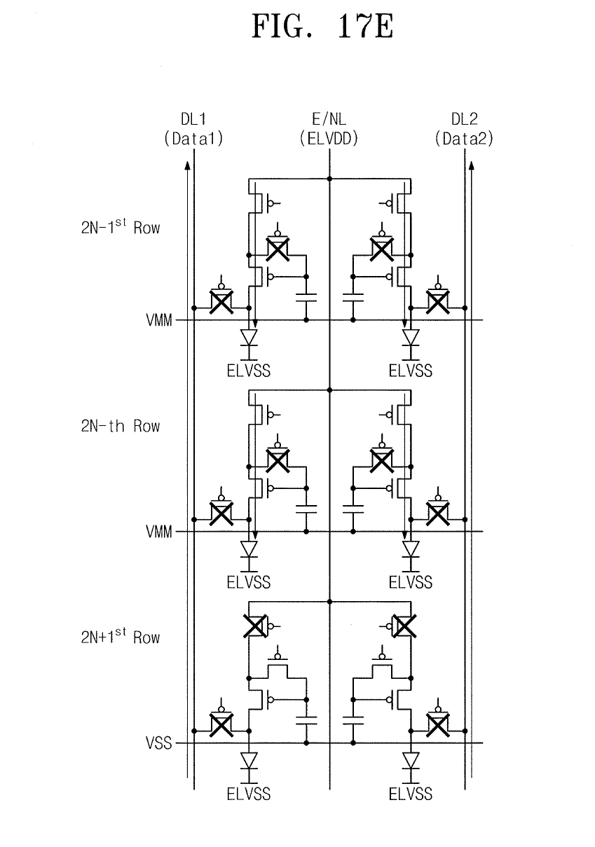

In FIG. 16, 1H indicates one horizontal scan period. In the fourth embodiment, Vinit and ELVDD are alternately supplied to the power supply line E/NL by a unit of a section corresponding to half the horizontal scan period. FIGS. 17A to 17E correspond to sections of FIG. 16, respectively. Unlike data voltage Data, each signal has a high-level voltage or a low-level voltage. In exemplary embodiments, p-type transistors are used which turn on when a low-level voltage is applied to a gate electrode of the transistor.

In FIG. 16, sections (A) through (E) are described with reference to FIG. 17, with operation of the pixel circuit 110 of a 2N-th row as the center. Referring to FIG. 17A, Vinit is supplied to a power supply line E/NL. First, since a high-level control signal is supplied to a gate line GL3 of the pixel circuit 110 of the 2N-th row and a low-level control signal and a low-level EM signal are supplied to a gate line GL2 and a light-emitting control line ECL, a write control transistor 112 is turned off and a switching transistor 113 and a power supply control transistor 112 are turned on. Initialization is performed when a voltage of a gate line GL1 transitions from VMM to VSS. Also, the write control transistor 112 and the switching transistor 113 of the pixel circuit 110 at the 2N−1st row are turned on in response to a low-level control signal applied to the gate lines GL2 and GL3. At this time, a data voltage is written at a capacitive element 114.

During a section corresponding to FIG. 17B, ELVDD is supplied to the power supply line E/NL. Also, voltages corresponding to gray scales are supplied to data lines DL1 and DL2 so that data voltages are programmed at the data lines DL1 and DL2. At this time, because a high-level control signal and a high-level EM signal are supplied to the gate line GL3 and the light-emitting control line ECL of the pixel circuit 110 at the 2N-th row, the power supply control transistor 111 and the write control transistor 112 are all turned off. For example, writing of a data voltage and light-emitting are not performed.

In the pixel circuits 110 at the 2N−1st and 2N+1st rows, a low-level EM signal is supplied to the light-emitting control line ECL, and a high-level control signal is applied to the gate lines GL2 and GL3. In this case, current is supplied to a current light-emitting element because the power supply control transistor 111 is turned on and the switching transistor 113 and the write control transistor 112 are turned off.

A section corresponding to C and D of FIG. 17 may correspond to half the one horizontal scan period, but Vinit is applied to the power supply line E/NL during the half the one horizontal scan period. First, a write control transistor 112 and a switching transistor 113 are turned on in response to low-level control signals applied to gate lines GL3 and GL2 of a pixel circuit 110 at the 2N-th row. A power supply control transistor 111 is turned off in response to a high-level EM signal applied to a light-emitting control line ECL. With this condition, a data voltage written at data lines DL1 and DL2 during a section corresponding to B of FIG. 17 is supplied to a capacitive element 114.

During a section corresponding to D of FIG. 17, control signals to be supplied to the gate lines GL3 and GL2 of the pixel circuit 110 at the 2N-th row transition to high-level control signals, thereby turning off the write control transistor 112 and the switching transistor 113. A voltage, held by the capacitive element 114 during a section corresponding to C of FIG. 17, is boosted because a potential of the gate line GL1 transitions from VSS to VMM.

In the pixel circuit 110 at the 2N−1st row, the write control transistor 112 and the switching transistor 113 are turned off in response to high-level control signals applied to the gate lines GL3 and GL2. An anode of the current light-emitting element 190 is discharged every frame. Therefore, an emitting of light by a leakage current of the driving transistor 115 is prevented when the current light-emitting element 190 displays a black gray.

During a section corresponding to C and D of FIG. 17, Vinit is supplied to the capacitive element 114. This is because the power supply control transistor 111 and the switching transistor 113 of the pixel circuit 110 at the 2N+1st row are turned on in response to a low-level EM signal and a low-level control signal applied to the light-emitting control line ECL and the gate line GL2. A voltage of the capacitive element 114 is initialized as a potential of the gate line GL1 transitions from VMM to VSS.

In a section corresponding to E of FIG. 17, ELVDD is applied to the power supply line E/NL. Also, as voltages corresponding to gray scales are supplied to data lines DL1 and DL2, data voltages are programmed on the data lines DL1 and DL2. In pixel circuits 110 at the 2N−1st and 2N-th rows, the power supply control transistor 111 is turned on in response to a low-level EM signal supplied to the light-emitting control line ECL. The switching transistor 113 and the write control transistor 112 are turned off in response to high-level control signals supplied to the gate lines GL2 and GL3. This condition enables a current, corresponding to a voltage held by the capacitive element 114, to be supplied to a current light-emitting element.

The power supply control transistor 111 and the write control transistor 112 are all turned off in response to a high-level control signal and a high-level EM signal applied to the gate line GL3 and the light-emitting control line ECL of the pixel circuit 110 at the 2N+1st row. In this case, writing of a data voltage or light-emitting may not be performed.

A sequence of operations of an optoelectronic device is described with an operation of the pixel circuit 110 at the 2N-th row as the center. After the above-described operations, a state corresponding to E FIG. 17 and a turn-off state are repeated until a next data voltage is written. With the above-described control method, initialization may be performed prior to one horizontal period, and a write period and a sufficient light-emitting duty ratio may be ensured.

### Fifth Embodiment

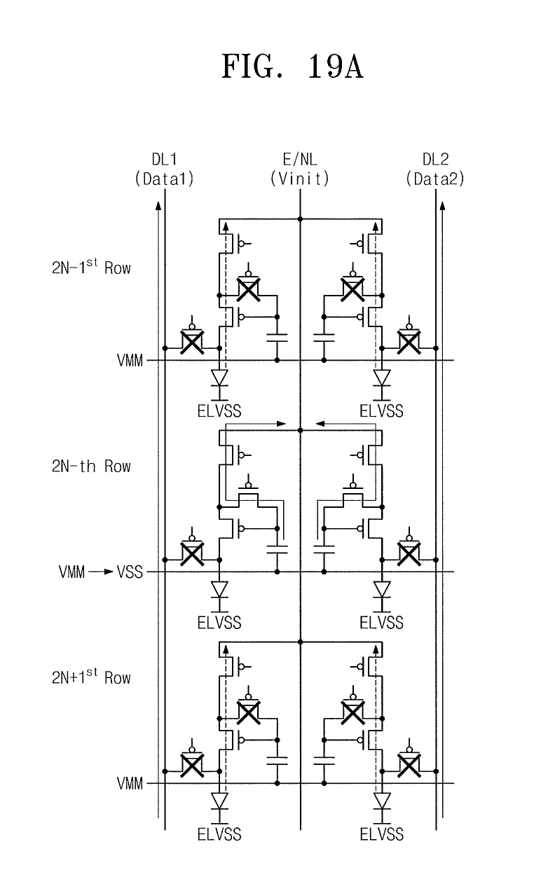

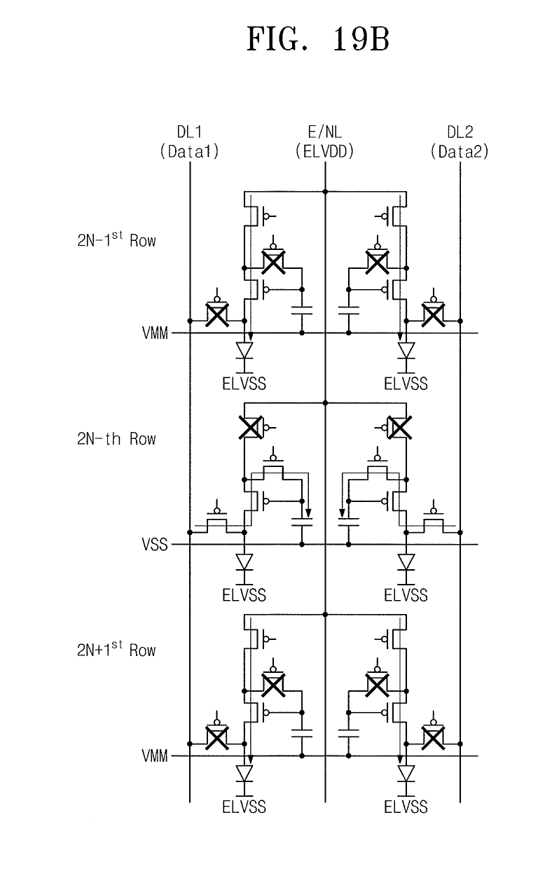

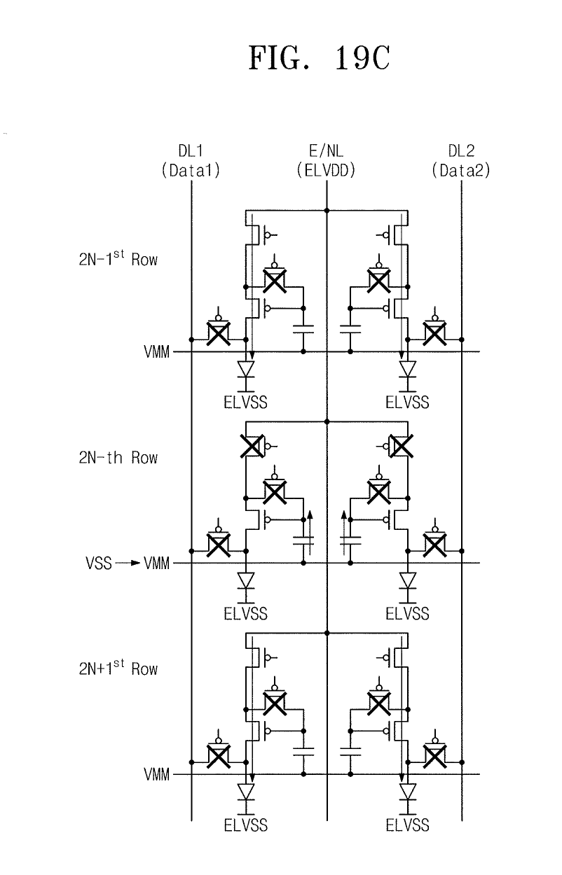

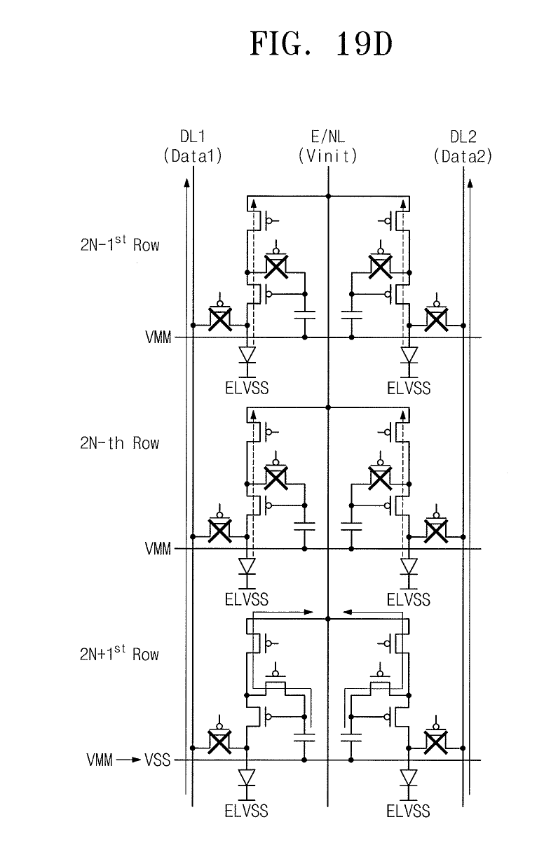

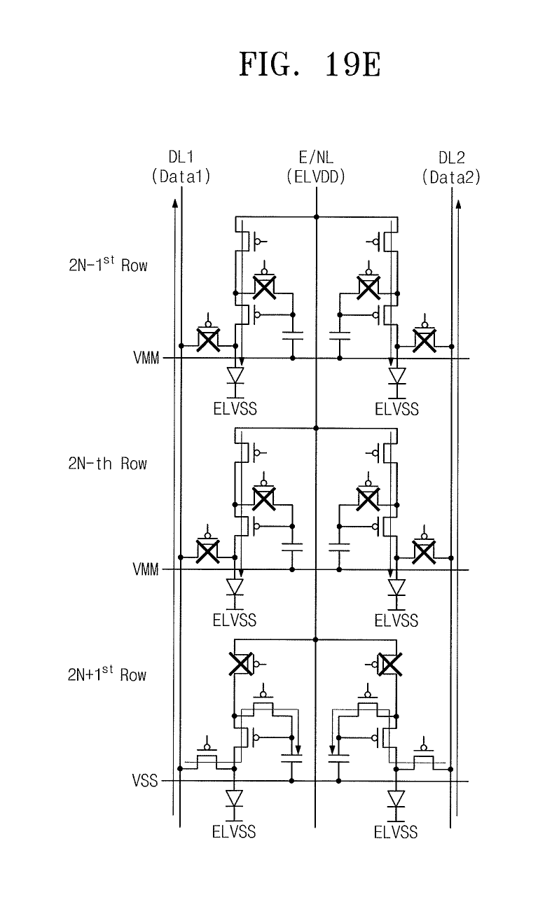

A fifth embodiment is described with reference to FIGS. 18 and 19. The fifth embodiment is the same as a fourth embodiment except for timing of each signal.

FIG. 18 illustrates timing of each signal associated with pixel circuits 110 at the 2N−1st and 2N+1st rows, according to a fifth embodiment. FIGS. 19A to 19E indicate states of pixel circuits 110 at the 2N-th, 2N−1st, and 2N+1st rows. Herein, ‘2N’ indicates an even number. Thus, the 2N-th row is an even-numbered row, and the 2N+1st and 2N−1st rows are odd-numbered rows.

As described above, since a power supply line may be disposed every two adjacent columns of pixel circuits 110, pixels 110 of two adjacent columns are connected to the same power supply line. Also, in FIG. 18, (2n), (2n−1), etc. attached to signal names denote signals to be supplied to a 2N-th row, a 2N−1st row, etc. For example, EM(2n) indicates a light-emitting control signal EM to be supplied to a 2N-th row.

In FIG. 18, 1H indicates one horizontal scan period. In the fifth embodiment, Vinit and ELVDD are alternately supplied to the power supply line E/NL by a unit of a section corresponding to half the horizontal scan period. In FIGS. 19A to 19E correspond to sections (A) to (E) of FIG. 18, respectively. Unlike data voltage Data, each signal has a high-level voltage or a low-level voltage. In exemplary embodiments, p-type transistors are used which turn on when a low-level voltage is applied to a gate electrode of the transistor.

In FIG. 18, sections (A) to (E) are described with reference to FIG. 19, with operation of a pixel circuit 110 of a 2N-th row as the center. Referring to FIG. 19A, Vinit is supplied to a power supply line E/NL. Data voltages corresponding to gray scales are programmed on data lines DL1 and DL2.

Since a high-level control signal is supplied to a gate line GL3 of the pixel circuit 110 of the 2N-th row and a low-level control signal and a low-level EM signal are supplied to a gate line GL2 and a light-emitting control line ECL, a write control transistor 112 is turned off and a switching transistor 113 and a power supply control transistor 112 are turned on. This condition enables Vinit to be supplied to a capacitive element 114.

Initialization is performed when a voltage of a gate line GL1 of the pixel circuit 110 at the 2N-th row transitions from VMM to VSS. Also, the write control transistors 112 of the pixel circuits 110 at the 2N−1st and 2N+1st rows are turned off in response to a high-level control signal applied to the gate line GL3, and the write control transistor 112 at the 2N-th row is also turned off as described above. At this time, a data voltage is not written at pixel circuits 110 of respective rows while data voltages corresponding to gray scales are written on the data lines DL1 and DL2.

During a section corresponding to FIGS. 19B and 19C, ELVDD is supplied to the power supply line E/NL. First, during a section corresponding to FIG. 19B, the write control transistor 112 and the switching transistor 113 are turned on in response to low-level control signals applied to the gate line GL3 and the gate line GL2 of the pixel circuit 110 at the 2N-th row. Also, the power supply control transistor 111 is turned off because a high-level EM signal is supplied to the light-emitting control line ECL.

During an initialization section corresponding to FIG. 19A, a driving transistor 115 has a gate voltage lower than the data voltages programmed at the data lines DL1 and DL2. Hence, if the data voltage written at each data line DL1/DL2 during the section corresponding to FIG. 19A is supplied to a second terminal of the driving transistor 115, the driving transistor 115 is turned on. At this time, the data voltage written at each data line DL1/DL2 is supplied to the capacitive element 114.

During a section corresponding to FIG. 19D, Vinit is supplied to the power supply line E/NL. Also, data voltages corresponding to gray scales are programmed at the data lines DL1 and DL2. In the pixel circuits 110 at the 2N-th and 2N−1st rows, the write control transistor 112 and the switching transistor 113 are turned off in response to high-level control signals applied to the gate line GL3 and the gate line GL2. In the pixel circuit 110 at the 2N+1st row, the write control transistor 112 is turned off because a high-level control signal is supplied to the gate line GL3. Thus, data voltages are not written at pixel circuits 110 at the 2N−1st, 2N-th, and 2N+1st rows while data voltages corresponding to gray scales are written at the data lines DL1 and DL2.

Also, Vinit is supplied to the capacitive element 114 because the power supply control transistor 111 and the switching transistor 113 of the pixel circuit 110 at the 2N+1st row are turned on in response to a low-level EM signal and a low-level control signal applied to the light-emitting control line ECL and the gate line GL2. A voltage of the capacitive element 114 is initialized as a potential of the gate line GL1 transitions from VMM to VSS.

In a section corresponding to FIG. 19E, ELVDD is applied to the power supply line E/NL. At this time, the power supply control transistor 111 is turned on in response to a low-level EM signal applied to the light-emitting control line ECL of the pixel circuits 110 at the 2N−1st and 2N-th rows, and the switching transistor 113 and the write control transistor 112 are turned off in response to high-level control signals applied to the gate lines GL2 and GL3 thereof. In this case, ELVDD is supplied to a first terminal of the driving transistor 115, so the driving transistor 115 is turned on. This enables a current, corresponding to a voltage held by the capacitive element 114, to be supplied to a current light-emitting element.

In the pixel circuit 110 at the 2N+1st row, since a high-level EM signal is supplied to the light-emitting control line ECL, the power supply control transistor 111 is turned off. Since low-level control signals are applied to the gate lines GL3 and GL2, the write control transistor 112 and the switching transistor 113 are turned on. At this time, a voltage the capacitive element 114 holds becomes lower than a data voltage written at each of the data lines DL1 and DL2, due to initialization performed during a section corresponding to FIG. 19D. Hence, if data voltages written on the data lines DL1 and DL2 during the section corresponding to FIG. 19D are supplied to second terminals of the driving transistors 115, the driving transistors 115 are turned on, and the data voltages written on the data lines DL1 and DL2 are supplied to the capacitive elements 114. As described above, also, light-emitting may not be performed because the power supply control transistor 111 is turned off.

A sequence of operations of an optoelectronic device according to a fifth embodiment is described with an operation of the pixel circuit 110 at the 2N-th row as the center. After the above-described operations, states corresponding to FIGS. 19D and 19E are repeated until a next data voltage is written. With the above-described control way, initialization may be made prior to one horizontal period, and a write period and a sufficient light-emitting duty ratio may be ensured.

### Sixth Embodiment

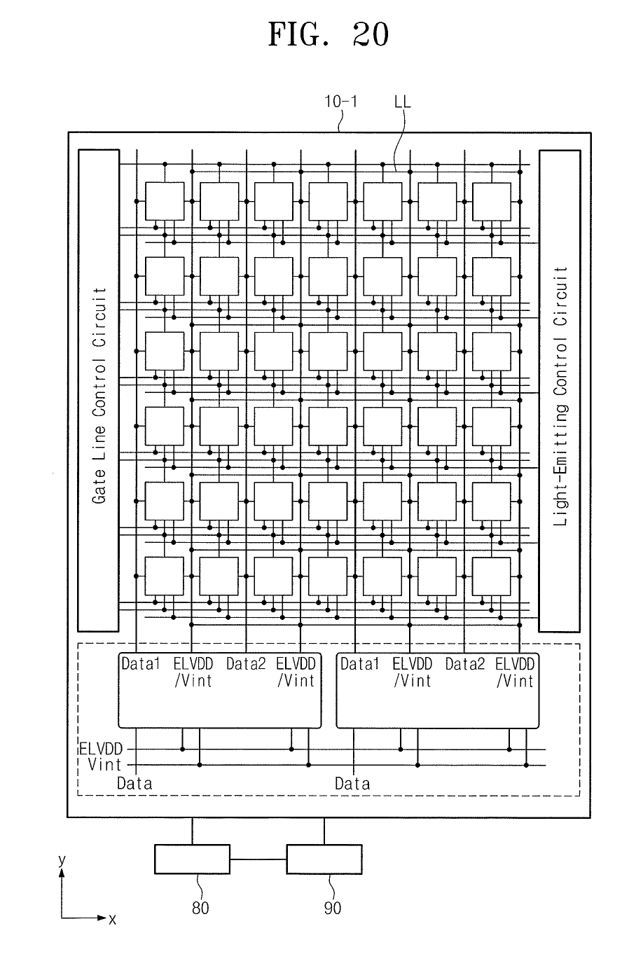

FIG. 20 illustrates an optoelectronic device 10-1 according to a sixth embodiment. In this embodiment, power supply lines E/NL are connected to a line extending in a horizontal direction. For example, the power supply lines are implemented in a mesh shape. Therefore, it is possible to reduce crosstalk. Herein, crosstalk may arise when a voltage drop variation between power supply lines is generated depending on the amount of current flowing into a current light-emitting element of each pixel circuit 110 connected to the power supply lines.

Also, it is possible to combine fourth through sixth embodiments. In this case, a combined embodiment may have the same effects as the fourth through sixth embodiments.

By way of summation and review, it is difficult to achieve a sufficient light-emitting duty ratio in a display device based on a ratio of the number of pixels turned on to the number of pixels turned off per frame. This difficulty may reduce display quality.

For example, in one proposed display device, a circuit corrects a variation in a threshold voltage of a driving transistor and makes it possible to obtain a certain light-emitting duty ratio. In such a device, the gate potential of a driving transistor must be quickly controlled with high accuracy to precisely control current to be supplied to a current light-emitting element.

However, the driving transistor of the pixel circuit is implemented with an n-type transistor. If the driving transistor of the pixel circuit is replaced with a p-type transistor, the gate of the driving transistor may supplied with an insufficient voltage. In this case, current is not supplied to a light-emitting element because the p-type transistor is turned off.

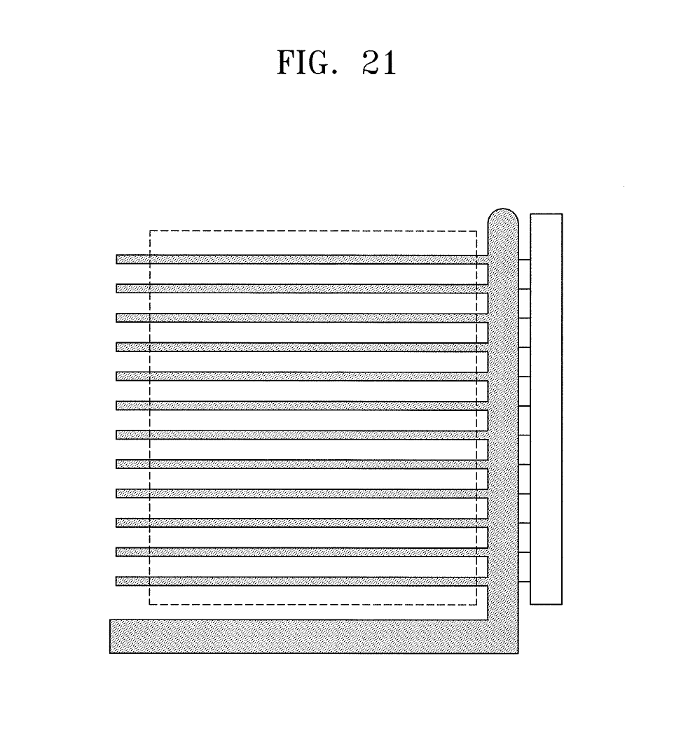

In another proposed display device, a pixel circuit performs initialization, and a driving transistor is implemented with a p-type transistor that has electron mobility lower than an n-type transistor. However, power lines are scanned to supply power for light-emitting to light-emitting elements while turning on or off the p-type transistors and have two values: a low potential and a high potential. In this case, as illustrated in FIG. 21, a driver for scanning a power line extending in a transverse direction of a substrate is disposed at left or right edges, which increases with width of that edge.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An optoelectronic device, comprising:
a plurality of pixel circuits arranged in a matrix;
a set of power supply lines extending in a first direction, the set of power supply lines including a first power supply line and a second power supply line between two adjacent columns of pixel circuits, a first voltage and a second voltage to be alternately applied to each of the first and second power supply lines;
a plurality of data lines, extending in the first direction, to transfer data voltages; and
a plurality of gate lines, extending a second direction intersecting the first direction, to transfer control signals, wherein each of the plurality of pixel circuits includes:
a light-emitter to emit light with a luminance based on an amount of applied current,
a write control transistor connected to a corresponding one of the plurality of data lines, the write control transistor to control writing of a data voltage,
a driving transistor to control the amount of current applied to the light-emitter,
a power supply control transistor connected to one of the first power supply line and the second power supply line, the power supply control transistor to control supply of the first voltage or the second voltage;
a switching transistor connected between a gate of the driving transistor and a source or drain of the power supply control transistor, the switching transistor to control a gate voltage of the driving transistor; and
a capacitive circuit having first terminal connected to the gate of the driving transistor and a second terminal connected to one of the plurality of gate lines, the capacitive circuit to hold a voltage corresponding to a gray scale value, wherein the first power supply line and the second power supply line are respectively connected to even-numbered rows and odd-numbered rows of pixel circuits in the two adjacent columns.

2. The optoelectronic device as claimed in claim 1, wherein the capacitive circuit is connected to a first gate line to receive one of third or fourth voltages, the fourth voltage higher than the third voltage.

3. The optoelectronic device as claimed in claim 1, further comprising:
a power supply line control circuit to control driving of the set of power supply lines, wherein the power supply line control circuit is disposed along the first direction.

4. The optoelectronic device as claimed in claim 1, wherein the write control transistor, the driving transistor, the power supply control transistor, and the switching transistor have a first conductivity type.

5. The optoelectronic device as claimed in claim 4, wherein the first conductivity type is p-type.

6. The optoelectronic device as claimed in claim 1, wherein one of the data voltages is lower than a light-emitting threshold voltage of the light-emitter.

7. The optoelectronic device as claimed in claim 1, wherein:
power supply lines, to which the first voltage is supplied during a first period, are connected to a first line extending the second direction, and
power supply lines, to which the second voltage is supplied during the first period, are connected to a second line extending the second direction.

8. A method for driving an optoelectronic device, the method comprising:
alternately supplying a first voltage and a second voltage to each of a first power supply line and a second power supply line connected to pixel circuits in adjacent columns, the second voltage different from the first voltage;
supplying current to a light-emitter through a driving transistor in at least one pixel circuit supplied with the first voltage; and
supplying the second voltage to a capacitive circuit through a switching transistor in at least one pixel circuit supplied with the second voltage.

9. The method as claimed in claim 8, further comprising:
writing a data voltage through a write control transistor in the at least one pixel circuit supplied with the first voltage.

10. The method as claimed in claim 9, wherein the data voltage is less than a threshold voltage of the light emitter.

11. The method as claimed in claim 8, further comprising:
supplying one of a third voltage or a fourth voltage to a gate line connected to the capacitive circuit, the fourth voltage greater than the third voltage.

12. The method as claimed in claim 8, wherein:
a control signal for controlling gate voltages of switching transistors of pixel circuits in a 2N-th row of the pixel circuits and a control signal for controlling gate voltages of write control transistors of the pixel circuits in a 2N−1st row are shared.

13. A method for controlling a driving circuit of a plurality of pixel circuits, the method comprising:
initializing a potential held by a capacitive circuit of a pixel circuit, initializing including turning off a write control transistor of the pixel circuit in a 2N-throw during a first period, the pixel circuit to receive a first voltage supplied to a power supply line;
supplying a predetermined data voltage to a data line by turning off the write control transistor of the pixel circuit in the 2N-th row during a second period, where a second voltage is supplied to the power supply line after the first period;
writing the predetermined data voltage at the pixel circuit at the 2N-th row through the write control transistor and boosting the written voltage during a third period, where the first voltage is supplied to the power supply line after the second period; and
supplying current to a light emitter of the pixel circuit at the 2N-th row through a driving transistor after the third period.

14. A method for controlling a driving circuit of rows of pixel circuits, the method comprising:
programming a data line connected to pixel circuits with a data voltage that corresponds to a gray scale value, the programming including turning off write control transistors of the pixel circuits in all rows, so that a data voltage corresponding to the gray scale value is supplied to the data line, and
initializing a potential held by a capacitive circuit in a pixel circuit at A 2N-th row, the initializing including turning on a power supply control transistor and a switching transistor of the pixel circuit at the 2N-th row, wherein the programming and the initializing are performed in a first period in which a first voltage is supplied to a power supply line connected to the pixel circuit at the 2N-th row.

15. An optoelectronic device, comprising:
a first column of pixel circuits;
a second column of pixel circuits; and
first and second power supply lines extending between the pixel circuits in the first and second columns, each of the first and second power supply lines to alternatively carry first and second voltages to the pixel circuits, wherein the first power supply line is connected to even-numbered rows of the pixel circuits and the second power supply line is connected to odd-numbered rows of the pixel circuits.

16. The device as claimed in claim 15, wherein the first and second power supply lines are parallel to data lines connected to the pixel circuits in the first and second columns.

17. The device as claimed in claim 15, wherein the first and second power supply lines extend in a direction which crosses a direction in which gates lines connected to the pixel circuits extend.

18. The device as claimed in claim 17, wherein each of the pixel circuits include a capacitive circuit connected between one of the gate lines and a driving transistor, the capacitive circuit to store a voltage to boost a gate voltage of the driving transistor.

19. The device as claimed in claim 15, wherein each of the first and second power supply lines is connected to a pixel circuit in the first column and a pixel circuit in the second column.

20. The device as claimed in claim 19, wherein:
the first voltage is a power voltage, and
the second voltage is an initialization voltage.
